(19) United States
(12) Patent Application Publication
(10) Pub. No.: US 2023/0152036 A1
(43) Pub. Date: May 18, 2023

(54) LOADING SYSTEM FOR A FREEZE DRYER, FREEZE-DRYING SYSTEM, AND CORRESPONDING METHOD

(71) Applicant: Groninger & Co. GmbH, Crailsheim (DE)

(72) Inventors: Armin MERZ, Ellwangen (DE); Roland ENGELHARD, Aurach-Weinberg (DE); Josef VEILE, Westhausen (DE)

(21) Appl. No.: 18/097,079

(22) Filed: Jan. 13, 2023

Related U.S. Application Data
(63) Continuation of application No. PCT/EP21/69658, filed on Jul. 14, 2021.

(30) Foreign Application Priority Data
Jul. 15, 2020 (DE) 10 2020 118 726.2

(51) Int. Cl. F26B 25/00; F26B 5/06

(52) U.S. Cl. CPC F26B 25/003; F26B 5/06

(57) ABSTRACT

A loading system for a freeze dryer, wherein the loading system is configured to load and/or unload the freeze dryer with containers filled with a medical, pharmaceutical or cosmetic substance. The loading system comprises a handling station and at least one carrier plate, wherein each carrier plate comprises a plurality of receptacles configured to each receive one of the containers, and the handling station comprises at least one handling device configured to handle the carrier plate in the handling station. A freeze-drying system having such a loading system, and a method for handling containers filled with, for example, a medical, pharmaceutical or cosmetic substance in such a loading system for a freeze dryer are also disclosed.

This is a Continuation application of International patent application PCT/EP2021/069658, filed Jul. 14, 2021, which claims the priority of German patent application DE 10 2020 118 726.2, filed Jul. 15, 2020. Both application PCT/EP2021/069658 and DE 10 2020 118 726.2 are herewith incorporated by reference in their entirety.

### FIELD

The present invention generally relates to a loading system for a freeze dryer, wherein the loading system is configured to load and/or unload the freeze dryer with containers filled with, for example, a medical, pharmaceutical or cosmetic substance. Furthermore, the present invention generally relates to a freeze-drying system with such a loading system. Furthermore, the present invention generally relates to a method for handling containers filled with, for example, a medical, pharmaceutical or cosmetic substance in a loading system for a freeze dryer.

### BACKGROUND

For packaging medical, pharmaceutical or cosmetic substances, it is common to dose these substances into containers and subsequently close them. As containers, for example, vials, carpules, cylindrical ampoules, bottles, syringes, and the like can be used.

Known packaging machines comprise, for packaging these substances, a filling station in which the containers are filled with the substance, a stopper placing station in which a stopper is placed on the containers, and a crimping station in which each container is closed with a crimping cap. The entire packaging process of the substances is performed in an aseptic environment, for example in a clean room or ultra-clean room.

Between the filling station and the crimping station, a freeze-drying station may additionally be arranged, in which the substance is freeze-dried in the containers.

Freeze-drying, which is also referred to as lyophilization or sublimation drying, is a method for gentle drying of products. Freeze-drying is based on the physical process of sublimation. Thereby, the ice crystals sublimate without any intermediate occurrence of a liquid phase directly into the gaseous state. The end product of freeze-drying is called a lyophilizate. Freeze-drying is particularly applied to thermally sensitive products.

Freeze-drying is particularly used for drying of pharmaceutical products. The pharmaceutical industry uses this method to dry drugs that would not be durable for long if dissolved in water. Before intake, the drugs are dissolved again in water.

For freeze-drying, the containers filled with the substance are inserted into a freeze dryer, which performs the freeze-drying. The freeze dryer can comprise, for example, a plurality of placement surfaces on different levels, on each of which several containers can be placed. The individual levels can also be referred to as shelves.

From the prior art, various loading techniques for freeze dryers are known.

For example, the containers can be inserted into the shelves individually or in groups. This loading process can be performed manually or automatically. Individual inserting of the containers into the freeze dryer is very time-consuming and therefore less desirable.

The insertion of container groups into the freeze dryer, i.e., the simultaneous insertion of several containers, requires more complex handling of the containers, since the containers should not be damaged during loading of a freeze dryer, and precise positioning of the containers within the freezer is desirable. The containers can be damaged by impacts, for example. When loading several containers at the same time, it should therefore be paid attention that the containers do not collide with each other. By precise positioning of the containers, a higher packing density can be achieved in the freezer and impacts can be avoided.

It is known, for example, from DE 10 2015 009 866 A1, to push several containers by means of a pusher from a transfer table over a loading bridge onto a placement plate within the freeze dryer.

The moving of individual or several containers within an isolator is disadvantageous, as this encourages impacts and impedes exact positioning.

Furthermore, loading techniques are known from the prior art in which the containers are arranged in transport containers or transport tubs, so-called trays, wherein these trays are inserted into the freeze dryer.

For example, document US 2014/093335 A1 shows a rail transport means for use in a manufacturing process for bottle preparation. The rail transport means provided with a rail and a sliding block slidably mounted on the rail. On the sliding block are provided a first movable guide track, a second movable guide track, a position switching device, and a material loading and unloading mechanism. The rail transport means is capable of automatically transferring feed trays between the filling area and other relative equipment participating in the manufacturing process, such as the freeze dryer and the sealing device, without requiring a manual engagement, thereby enabling the manufacturing process for bottle preparation to be performed in a dust-free and sterile environment, wherein the product yield and the production efficiency are increased.

Furthermore, document WO 2013/098834 A1 shows a loading device for loading containers into freeze dryers that are not configured for automatic loading.

By the loading of a freeze dryer with trays in which the containers are arranged, it is avoided that individual or several containers have to be moved, in particular pushed. This facilitates the handling of a group of containers as well as the positioning of the containers. However, the containers are loosely arranged in the trays and can collide with each other. Moreover, the arrangement in these trays impedes accessibility to the individual containers within a tray.

Furthermore, loading techniques are known from the prior art in which the containers are arranged in nests, wherein the nests with the containers are inserted into the freeze dryer. A nest is understood to be a carrier that comprises receptacles for the containers.

For example, document WO 2013/164422 A2 shows that in a method and a device for treatment or processing of containers used for storing substances for medical, pharmaceutical or cosmetic applications or containing the same, cylindrical containers open at at least one end are automatically guided past or pass through treatment stations for treatment or processing by means of a conveyor device, while the processing stations are jointly held by a carrier in a regular two-dimensional arrangement. The carrier has several openings or containers that determine the regular arrangement. The treatment or processing of the containers is performed at or in at least one of the processing stations while the containers are held by the carrier. This opens up new possibilities for the treatment or processing of the containers, for example, during crimping of metal covers or during freeze-drying.

Furthermore, document WO 2016/075647 A1 discloses a freeze-drying method in which several vials are not in contact with the shelf of the freeze-drying apparatus. The present application is further directed to freeze-drying product and intermediate product that are obtainable by means of this method.

Furthermore, document WO 2016/125095 A1 shows a method for freeze-drying a substance, comprising: placing at least one vial containing the substance in a freeze-drying chamber, wherein the at least one vial comprises an opening into which a stopper is inserted in a closed state not allowing gas exchange between the interior and the exterior of the vial; providing mechanical means external to the stopper that are arranged at the opening to restrict upward movement of the stopper; lowering the temperature in the freeze-drying chamber to a predefined value below the freezing temperature of the substance and reducing the pressure in the freeze-drying chamber to a predefined pressure at a predefined temperature, the predefined pressure being chosen such that the force exerted by it on the stopper lifts the stopper from the closed state to an exchange state in which the stopper is only partly inserted in the opening of the vial thereby allowing gas exchange between the interior and the exterior of the vial, wherein the lowering of the temperature within the freeze-drying chamber to the predefined value is performed before the pressure in the freeze-drying chamber is reduced to the predefined pressure, and wherein the lifting of the stopper from the closed state abruptly lowers the pressure in the at least one vial, thereby initiating nucleation in the substance in that vial. In addition, mechanical means are provided which can be used to perform the method for freeze-drying a substance.

Furthermore, document WO 2017/178895 A1 shows systems and methods for aseptically filling pharmaceutical containers with a pharmaceutical substance and then lyophilizing it. The system and the method can employ a lyophilizer loader subsystem having an interior chamber in communication with an interior chamber of a lyophilizer subsystem via a portal with a sealable door, with the collective interior being aseptically sealable. An articulated robotic arm can be employed to batch transfer to the lyophilizer subsystem container nests bearing the pharmaceutical containers. In one embodiment, the nests may be transferred serially to the loader subsystem, with the articulated robotic arm being configured to transfer the nests of containers in batches to the lyophilizer subsystem. The articulated robotic arm can also be configured to be used to move batches of nests within the lyophilizer subsystem. One implementation includes two articulated arms and a joint rotary wrist driven by two rotary shoulders.

Furthermore, document EP 2 886 983 A1 shows a holder structure for simultaneously holding a plurality of containers for substances for cosmetic, medicinal or pharmaceutical applications. The holder structure comprises a carrier comprising a plurality of openings or receptacles into which the containers can be inserted, as well as holding means for holding the containers in the openings or receptacles of the holder structure, wherein the holder structure comprises a longitudinal direction (x) and a transversal direction (y). Respectively immediately adjacent holder structures can be directly connected with each other such that they are immovable relative to each other in the longitudinal direction and/or in the transversal direction. The releasable, temporary connection allows a plurality of holder structures to be connected with each other and to be jointly inserted into a processing or process station, such as a freeze dryer, and removed therefrom again.

Nests, like trays, facilitate the handling of groups of containers. In addition, arrangement in nests prevents containers from being able to collide with each other. The nests used in the prior art for loading a freeze dryer, however, are designed so as to impede the accessibility to the containers, making it difficult to insert the containers into the nest and to remove the containers from the nest. This follows on the one hand from the fact that the used nests are usually designed so as to protect the containers over a large area. For this, the individual receptacles of the nest are configured such that they reach to the neck of the bottle or to the filling opening of the individual containers. This makes the accessibility to the containers more difficult. Alternatively, the nests used in the prior art are designed such that the containers hang freely in the nests, that is, are held at the neck of the bottle. This also makes accessibility to the containers as well as inserting and removing them more difficult, since in such nests two handling devices are required for removing and inserting, one arranged below the containers to lift a container from a receptacle of the nest or place it therein, and a further one arranged above the containers to grip and transfer a lifted container.

The known loading techniques for freeze dryers still leave room for improvements. In particular, there is a need regarding easy, safe and accurate handling of a plurality of containers when inserted into a freeze dryer. Furthermore, means used to handle the containers shall be compact and easy to handle or control.

### SUMMARY

It is therefore an object of the present application to provide a loading system for a freeze dryer and a method for loading a freeze dryer by means of which a plurality of containers can be simply, safely, and accurately inserted into a freeze dryer.

Furthermore, it is an object of the present application to provide a loading system for a freeze dryer and a method for loading a freeze dryer, which enable easy handling.

In a first aspect, there is provided a loading system for a freeze dryer, wherein the loading system is configured to load and/or unload the freeze dryer with containers filled with a medical, pharmaceutical or cosmetic substance, wherein the loading system comprises a handling station and at least one carrier plate, wherein each carrier plate comprises a plurality of receptacles configured to each receive one of the containers, wherein the handling station comprises at least one handling device configured to handle the carrier plate in the handling station.

In a second aspect, there is provided a freeze-drying system having a freeze dryer and the loading system according to the first aspect.

In a third aspect, there is provided a method for handling containers filled with a medical, pharmaceutical or cosmetic substance in a loading system for a freeze dryer, wherein the method comprises the following steps for loading the freeze dryer:
providing a carrier plate in a handling station, wherein the carrier plate comprises a plurality of receptacles configured to each receive one of the containers;
feeding containers to the handling station;
inserting the containers into the receptacles of the carrier plate by means of a first handling device; and
inserting the carrier plate into the freeze dryer by means of a second handling device.

In a fourth aspect, there is provided a method for handling containers filled with a medical, pharmaceutical or cosmetic substance in a loading system for a freeze dryer, wherein the method comprises the following steps for unloading the freeze dryer:
providing a carrier plate in the freeze dryer, wherein the carrier plate comprises a plurality of receptacles configured to each receive one of the containers, wherein in the receptacles of the carrier plate containers are inserted;
removing the carrier plate from the freeze dryer by means of a second handling device;
removing the containers from the receptacles of the carrier plate in a handling station by means of a first handling device; and
removing the containers from the handling station by means of a transport device.

In general, a plate is a flat, planar and, in particular, stiff component. A plate comprises in a first and second spatial direction a base surface and in a third spatial direction a thickness. The spatial directions are each pairwise perpendicular to each other. The first and second spatial directions can also be referred to as the length and width directions of the carrier plate. The third direction corresponds to a height direction of the carrier plate. Correspondingly, the plate has in the length direction a length and in the width direction a width, wherein the length is greater than or equal to the width. The thickness of the carrier plate is thereby substantially smaller than the length and width of the plate. Substantially smaller can mean, for example, that the length and width of the plate are at least five times as large, preferably at least seven times as large, in particular at least ten times as large, as the thickness of the plate. The base surface can in principle comprise any arbitrary shape. For example, the base surface can be round, oval, triangular, quadrangular, or polygonal. In particular, the plate can comprise a rectangular or square shape. In other words, the plate can be, for example, a rectangular or square plate.

A carrier plate is a plate configured to support objects on its plane. The carrier plate is thus configured to support containers on its plane. A carrier plate can also be referred to as a plate-shaped carrier.

The thickness of the carrier plate can amount to 0.5 cm to 2 cm, preferably 0.8 cm to 1.5 cm, in particular 1 cm. A length of the plate can preferably amount to 10 cm to 150 cm, preferably to 20 cm to 80 cm, in particular to 30 cm, 40 cm, 50 cm, 60 cm or 70 cm. A width of the plate can preferably amount to 10 cm to 150 cm, preferably to 20 cm to 80 cm, in particular to 30 cm, 40 cm, 50 cm, 60 cm or 70 cm. In the case of a rectangular plate, the length of the plate can be, for example, twice the width of the plate. In the case of a square plate, length and width are of equal size.

As containers, for example, vials, carpules, cylindrical ampoules, bottles, syringes, and the like can be used. For example, the containers can comprise a cylindrical shape. The containers can comprise a volume between 1 ml and 100 ml. The containers can comprise a diameter between 10 mm and 100 mm, in particular between 16 mm and 30 mm. The containers can comprise a height between 20 and 200 mm, preferably between 35 mm and 75 mm. In particular, as containers, vials of types 2R to 30R according to DIN/ISO 8362 can be used. These container types are listed below in Table 1.

TABLE 1

| Typ | Volume [ml] | Diameter [mm] | Height [mm] | Wall thickness [mm] |
|---|---|---|---|---|
| 2R | 4 | 16 | 35 | 1 |
| 4R | 6 | 16 | 45 | 1 |
| 6R | 10 | 22 | 40 | 1 |
| 8R | 11.5 | 22 | 45 | 1 |
| 10R | 13.5 | 24 | 45 | 1 |
| 15R | 19 | 24 | 60 | 1 |
| 20R | 25 | 30 | 55 | 1.2 |
| 25R | 30.5 | 30 | 65 | 1.2 |
| 30R | 36 | 30 | 75 | 1.2 |

A container of type 2R is designed for a filling quantity of 2 ml. Correspondingly, the containers of types 4R to 30R are designed for filling volumes of 4 ml to 30 ml. The number in the type designation thus indicates the intended filling quantity of the substance to be filled.

The receptacles of the carrier plate are configured such that each receptacle can receive a respective container. In other words, each receptacle is configured for the reception of respectively one container. The receptacles are arranged on the plane of the carrier plate so that the containers, when arranged in the receptacles, are carried by the carrier plate. In other words, this plane of the carrier plate in the operating state, i.e., when the containers are carried, is an upper side of the carrier plate, so that the containers stand on the plane, i.e. on the upper side, of the carrier plate when the containers are received in the receptacles and are carried by the carrier plate. In other words, the containers are held in the receptacles in the operating state. Through this, it is achieved that the containers are safely spaced apart from each other when inserted into the freeze dryer or when removed from the freeze dryer and thus cannot bump or rub each other. Furthermore, the containers can also be easily placed and gripped again by a tool of the handling device.

By the plate-shaped configuration of the carrier plate, it is furthermore achieved that the containers can be easily placed on the carrier plate in the receptacles or received from the carrier plate out of the receptacles. Due to the plate-shaped, i.e., flat, configuration, only a lower part of the containers, for example a bottom portion, is arranged in the receptacles. In other words, each receptacle holds only a bottom portion of the respective container arranged therein. In this way, a majority of a container is accessible so that the containers can be easily inserted into the receptacles and removed again therefrom. In other words, the carrier plate can be more easily equipped with containers and subsequently emptied again.

The handling station in which the carrier plates and containers are handled is preferably arranged outside the freeze dryer. For handling of the carrier plates and the containers, one or more handling devices are provided in the handling station, which are configured to handle the carrier plates and/or the containers in the handling station.

By the proposed loading system, freeze-drying system and method, means are provided for inserting containers filled with a pharmaceutical substance into a freeze dryer, by means of which a plurality of containers can be easily, safely, and accurately inserted into a freeze dryer. Furthermore, these means themselves are easy to handle and control.

In a first refinement, the receptacles of each carrier plate are configured by recesses in the surface of the respective carrier plate.

When a container is received in a receptacle, the container thus stands in the recess and is held by the edge of the recess. The recess can comprise a depth of 0.1 cm to 1 cm, preferably 0.3 to 0.7 cm, in particular 0.5 cm. Preferably, the recesses are at maximum half as deep as a height of the containers, so that a maximum of 50% of the container is enclosed by the receptacle. The depth of the recess can correspond to 5% to 50%, preferably 7% to 20%, in particular 10% of the height of the containers.

In other words, the recesses are configured to receive a bottom part or bottom portion of the container. In particular, at least 50% of the container can extend out of the recess. As a result, the handling is improved because the containers are better accessible hereby.

In a further refinement, the receptacles of each carrier plate comprise a cylindrical shape.

In particular, the recesses of the receptacles can be configured cylindrically. The shape of the receptacles can thus be adapted to cylindrical containers. As a result, in particular cylindrical containers can be held in the receptacle such that they contact the edge of the receptacle over their full circumference. In this way, a secure hold in the receptacle is improved.

In a further refinement, each carrier plate comprises a first side surface on which the corresponding receptacles are arranged.

In principle, a plate comprises two side surfaces that are arranged on opposite sides of the plate and extend in the width and length directions. The two side surfaces are thus distanced from each other corresponding to the thickness of the plate.

In a further refinement, the first side surface in an operating position is the top side of the carrier plate.

In the operating position, the top side of the carrier plate is the side on which the containers can stand. Accordingly, the second side surface in this operating position is the bottom side of the carrier plate. The bottom side is arranged opposite to the top side. In the operating position, no containers can stand on the bottom side. In this operating position, the containers are arrangeable in the receptacles. Thereby, the respective containers stand in the corresponding receptacles on the carrier plate. The second side surface can also comprise receptacles for containers. Alternatively, the second side surface can also comprise no receptacles for containers.

In a further refinement, the receptacles are distributed at regular distances, in particular according to a regular pattern, on the first side surface.

A regular distribution of the receptacles facilitates the insertion and removal of the containers. For example, the receptacles can be arranged in rows.

In a further refinement, each receptacle comprises the same distance to adjacent receptacles.

In this way, the inserting and removing of the containers is further facilitated.

In a further refinement, the receptacles are distributed in a pattern on the first side surface, wherein the pattern is configured such that the receptacles are each arranged adjacent each other in two or three spatial directions.

In the case of two spatial directions, the two spatial directions can be arranged orthogonally to each other. In the case of three spatial directions, the three spatial directions can be arranged at an angle of 60° to each other. Both patterns provide a highly ordered distribution of receptacles. In both patterns, the receptacles of one type are arranged in rows. The arrangement in rows allows that several containers, in particular a complete row of containers, can be arranged in receptacles simultaneously and at the same time easily. The second pattern, in which the receptacles are arranged spaced apart from each other in three spatial directions, is particularly preferred because this pattern allows the best packing density of containers on the carrier plate.

In a further refinement, each carrier plate comprises a first coupling portion by means of which the carrier plate is couplable with a corresponding second coupling portion of another object.

In the coupled state, the movement of the carrier plate is coupled with the movement of the other object. As a result, the carrier plate and the other object are movable together. For example, the carrier plate can be moved by the other object. In this way, the handling of the carrier plate can be further improved.

In a further refinement, the first coupling portion is arranged on a first edge side of the carrier plate.

The edge sides extend between the first side surface and the second side surface, that is, in at least one operating state, between the top side and the bottom side. The edge sides of a carrier plate are better accessible for coupling than the first and second side surfaces. The first edge side is arranged opposite to a second edge side. Preferably, the first coupling portion is arranged centrally on the first edge side. In other words, the first coupling portion is arranged on the first edge side where a center axis of the carrier plate that extends from the first edge side to the second edge side intersects the first edge side. In the operating position of the carrier plate, the center axis is arranged parallel to the insertion direction. The center axis runs in particular parallel to the side surfaces and perpendicular to the first and second edge side.

In a further refinement, the first coupling portion comprises a holding member, wherein the second coupling portion of the other object is engageable with the holding member for coupling.

The holding member can comprise, for example, a rod or a web with which the first coupling portion is engageable with a corresponding element of the second coupling portion. The element of the second coupling portion can be, for example, configured hook-shaped so as to be engageable with the holding member. For example, the member of the second coupling portion can hook with the holding member to couple the first coupling portion with the second coupling portion. In this way, a simple coupling of the coupling portions is enabled.

In a further refinement, the first coupling portion comprises a recess, wherein the holding member is arranged in the recess, wherein the recess is configured such that the second coupling portion of the other object can engage the recess to couple the carrier plate with the other object.

Preferably, the recess is arranged at the first edge side and is open outwardly. The recess can be open at the first edge side and at the first side surface and/or the second side surface. The recess can in particular extend from the first side surface to the second side surface. In particular, the recess can be configured in a U-shape. The holding member can extend through the recess, in particular from a first side of the recess to a second, opposite side of the recess. By engaging the second coupling portion in the recess, the coupling is further simplified.

In a further refinement, the other object is a first adjacent carrier plate.

In other words, the carrier plate comprises a first coupling portion and the adjacent carrier plate comprises a corresponding second coupling portion, wherein the two carrier plates can be coupled with each other by means of the two coupling portions. In the coupled state, the two carrier plates can be moved together. In this way, the handling of several carrier plates is simplified. In particular, several carrier plates can be inserted together into the freeze dryer or removed therefrom again in the coupled state. Furthermore, the carrier plates can also be moved together on a placement surface within the freeze dryer, in particular pulled or pushed. As a result, the handling and positioning of several carrier plates in one freeze dryer is improved.

In a further refinement, each carrier plate comprises a second coupling portion by means of which the carrier plate is couplable with a corresponding first coupling portion of a second adjacent carrier plate.

The carrier plate thus comprises two coupling portions by means of which the carrier plate is couplable with an adjacent carrier plate and with a further object. The further object can be, for example, a further adjacent carrier plate, so that by means of the coupling portions three or more carrier plates are couplable with each other. The further object can also be a handling tool, for example a handling robot, by means of which the carrier plate and the adjacent carrier plate coupled with the carrier plate via the second coupling portion can be moved. As a result, the handling and positioning of several carrier plates, in particular in a freeze dryer, is further improved.

In a further refinement, the second coupling portion of the carrier plate is arranged on a second edge side of the carrier plate that opposes the first edge side.

In this way, for example, three or more carrier plates or two carrier plates and a further object can be coupled with each other in a row. Preferably, the second coupling portion is arranged centrally on the second edge side. In other words, the second coupling portion is arranged on the second edge side where the center axis of the carrier plate intersects the second edge side.

In a further refinement, the second coupling portion comprises a locking member, wherein the first coupling portion is engageable with the locking member for coupling.

The locking member can comprise, for example, a hook or hook-shaped member with which the second coupling portion is engageable with a corresponding member (for example, the aforementioned holding member) of the first coupling portion. For example, the hook-shaped member of the second coupling portion can hook with the holding member to couple the first coupling portion to the second coupling portion. In this way, simple coupling of the coupling portions is enabled.

In a further refinement, the holding member of the first coupling portion of the carrier plate is configured such that the locking member of the second coupling portion of the first adjacent carrier plate can be engaged with the holding member of the first coupling portion of the carrier plate to couple the carrier plate with the first adjacent carrier plate.

The holding member of the first coupling portion of the carrier plate is preferably configured such that the locking member of the second coupling portion of the first adjacent carrier plate can engage the recess of the holding member of the first coupling portion of the carrier plate to couple the carrier plate with the first adjacent carrier plate. In this way, two carrier plates can be easily handled together.

In a further refinement, the locking member of the second coupling portion of the carrier plate is configured such that it can be engaged with the holding member of the first coupling portion of the second adjacent carrier plate to couple the carrier plate with the second adjacent carrier plate.

The locking member of the second coupling portion of the carrier plate is preferably configured such that it can engage the recess of the holding member of the first coupling portion of the second adjacent carrier plate to couple the carrier plate with the second adjacent carrier plate. In this way, two carrier plates can be easily handled together.

In a further refinement, the loading system comprises a plurality of carrier plates.

Each carrier plate can be configured as previously described. In particular, each carrier plate can comprise a first and a second coupling portion, wherein the carrier plates are couplable with each other by means of the coupling portions and can form carrier plate assemblies. A carrier plate assembly comprises a plurality of carrier plates, wherein the carrier plates are coupled with each other. For example, adjacent carrier plates can be coupled with each other by means of the corresponding first and second coupling portions, in particular such that these carrier plates can be pushed and pulled together. In this way, several carrier plates can be handled together.

In a further refinement, each carrier plate comprises two third coupling portions by means of which the carrier plate is couplable with corresponding coupling portions of another object.

In the coupled state, the movement of the carrier plate is coupled with the movement of the other object. As a result, the carrier plate and the other object are movable together. For example, the carrier plate can be moved by the other object. In this way, the handling of the carrier plate can be further improved. By the use of two coupling portions for transferring the carrier plate, the carrier plate can be transferred more stably.

In a further refinement, the two third coupling portions are arranged on the second edge side of the carrier plate.

Preferably, the third coupling portions are arranged symmetrically with respect to the center axis of the carrier plate. The second coupling portion of the carrier plate is thus arranged between the two third coupling portions of the carrier plate. In particular, the second coupling portion comprises the same distance to both third coupling portions.

In a further refinement, each third coupling portion comprises a holding member, wherein the coupling portion of the other object is engageable with the holding member for coupling.

The holding member can comprise, for example, a rod or a web with which the respective coupling portion is engageable with the coupling portion of the other object. The member of the second coupling portion can be, for example, configured hook-shaped so as to be engageable with the holding member. For example, the member of the second coupling portion can hook with the holding member to couple the first coupling portion with the second coupling portion. In this way, a simple coupling of the coupling portions is enabled.

In a further refinement, each third coupling portion comprises a recess, wherein the holding member is arranged in the recess, wherein the recess is configured such that the coupling portion of the other object can engage the recess in order to couple the carrier plate with the other object.

Preferably, the recess is arranged at the second edge side and is open outwardly. The recess can be open at the second edge side and at the first side surface and/or the second side surface. The recess can in particular extend from the first side surface to the second side surface. In particular, the recess can be configured to be U-shaped. The holding member can extend through the recess, in particular from a first side of the recess to a second, opposite side of the recess. By engaging the coupling portion of the other object in the recess, the coupling is further simplified. For example, the other object can be a receiving device or a linear unit of a handling device. The other object can also be a robot.

In a further refinement, a first handling device of the at least one handling device is configured to insert the containers into the receptacles of the carrier plate and/or to remove them again from the receptacles after freeze-drying.

By the use of a carrier plate, the containers can be easily inserted into or removed from the receptacles by means of the first handling device, since the carrier plate enables good accessibility to the containers. For insertion, for example, the first handling device can grip the containers, transfer them to the receptacles and place them in the receptacles. Correspondingly, for removal, the first handling device can grip the containers, lift/raise them out of the receptacles, and transfer them further. The handling device can be configured to handle one or several containers simultaneously. The handling device can equip all receptacles with containers during insertion. The handling device can remove all containers received in the receptacles from the receptacles during removal.

In a further refinement, the first handling device comprises a handling robot having a gripping device for gripping containers.

By means of the gripping device, the containers can be easily gripped and handled. The handling robot can comprise an end effector, wherein the gripping device is arranged at the end effector. The end effector can comprise the gripping device or support the gripping device. The handling robot preferably comprises a multi-jointed arm, at the end of which the end effector is arranged. The arm thus carries the end effector. The end effector can be moved in space by means of the arm. For moving the arm, drive means, such as one or more drive devices, can be provided. The arm can be attached to a support structure arranged in or at the handling station. The reach of the arm is preferably such that the end effector for loading and unloading a carrier plate with containers is movable between the carrier plate (in particular a transfer plate described in the following) and a feeder/remover for the containers (in particular a container holder described in the following or a transport device described in the following).

In a further refinement, the loading system comprises a transport device configured to feed the containers to the handling station and/or remove the freeze-dried containers from the handling station.

The transport device can be configured to feed the containers to the handling station and remove the freeze-dried containers from the handling station. Alternatively, two different transport devices can also be provided, wherein a first transport device is configured to feed the containers to the handling station and a second (further) transport device is configured to remove the freeze-dried containers from the handling station. The transport device(s) thus provide a feed or remove for the containers to/from the handling station. For example, the transport device(s) can feed the containers from an upstream filling module with filling station and stopper placing station to the handling station. Furthermore, the transport device(s) can remove the containers from the handling station to a downstream crimping module with crimping station.

In a further refinement, the transport device comprises a handling robot configured to handle the containers individually or to handle several containers together, in particular in pairs.

The handling robot of the transport device can be configured to receive the containers individually or in pairs from an upstream filling module for feeding and to transfer them to the handling station (in particular to a container holder in the handling station described in the following). Correspondingly, the handling robot of the transport device or the further transport device can be configured to, for removing, transfer the containers individually or in pairs from the handling station (in particular from a container holder in the handling station described below) to a downstream crimping module and to transfer the containers to the crimping module. For handling the containers, the handling robot can comprise a gripping device by means of which one or several containers can be gripped simultaneously. For example, the handling robot can comprise an end effector, wherein the gripping device is arranged at the end effector. The end effector can comprise the gripping device or support the gripping device. The handling robot preferably comprises a multi-jointed arm, at the end of which the end effector is arranged. The arm thus carries the end effector. The end effector can be moved in space by means of the arm. For moving the arm, drive means, such as one or more drive devices, can be provided. The arm can be fixed to a support structure that is arranged in or at the handling station. The reach of the arm is preferably such that the end effector is movable between the handling station and the filling module and/or the crimping module in order to be able to transfer the containers between the handling station and the filling module or between the handling station and the crimping module, respectively.

In a further refinement, the handling station comprises a container holder in which fed containers or containers to be transported away are arrangeable.

In the container holder, fed containers or containers to be transported away can thus be temporarily stored or collected. The container holder is thus an intermediate storage location between the feeder (in particular the transport device) and the first handling device.

In a further refinement, the container holder comprises a plurality of receptacles each for receiving a container.

In this way, a plurality of containers can be collected or temporarily stored in the container holder.

In a further refinement, the receptacles of the container holder are arranged in a row.

Both the transport device and the first handling device can be configured to handle several containers simultaneously, i.e., to receive, transfer, and place several containers simultaneously. When the receptacles of the container holder are arranged in a row, the simultaneous insertion of several containers into the container holder and the simultaneous removal of several containers from the container holder is facilitated.

In a further refinement, the first handling device is configured to remove one or more containers from the container holder, transfer them to the carrier plate, and insert them into empty receptacles of the carrier plate.

In this way, the first handling device can remove the fed and temporarily stored containers from the receptacles of the container holder and insert them into or arrange them in the receptacles of the carrier plate.

In a further refinement, the first handling device is configured to remove one or more containers from the receptacles of the carrier plate, transfer them to the container holder, and insert them into the container holder.

In this way, the first handling device can remove the freeze-dried containers from the receptacles of the carrier plate and place or arrange them in the receptacles of the container holder for temporary storage prior to removal.

In a further refinement, the first handling device is configured to handle a row of containers.

For removing a row, the gripping device of the first handling device can comprise, for example, several gripping members for gripping individual containers, wherein the gripping members are arranged in a row. Each gripping member can comprise a receptacle formed by two receiving members that are displaceable between a gripping position in which a container can be gripped and a receiving position in which a container can be received. The handling of a row of containers is particularly advantageous when the containers in the container holder and in the carrier plate are also arranged in rows, in particular when the receptacles of the container holder and of the carrier plate are each arranged in rows.

In a further refinement, a second handling device of the at least one handling device is configured to insert the carrier plate into the freeze dryer for loading the freeze dryer and/or to remove the carrier plate from the freeze dryer again for unloading the freeze dryer.

By means of the second handling device, a carrier plate equipped with containers can thus be easily inserted into the freeze dryer and removed from the freeze dryer again after freeze-drying.

In a further refinement, the second handling device is configured to push the carrier plate from the handling station into the freeze dryer for loading the freeze dryer and/or to pull the carrier plate out of the freeze dryer again for unloading the freeze dryer.

In a further refinement, the second handling device comprises a linear unit, in particular a pusher, by means of which the carrier plate is pushable and/or pullable.

By means of the linear unit, the carrier plate can be pushed into the freeze dryer, for example, from the handling station. In particular, a pusher can push the carrier plate from a transfer plate (which is described further below) of the handling station onto a placement surface within the freeze dryer. The pusher can comprise, for example, a pushing member that can be brought into contact with an edge side of the carrier plate in order to push the carrier plate.

In a further refinement, the carrier plate comprises at least one coupling portion, wherein the linear unit is couplable with the at least one coupling portion to pull and/or push the carrier plate. The coupling portion can in particular be the first coupling portion. Alternatively, the at least one coupling portion can also comprise the two third coupling portions of the carrier plate.

Preferably, the pushing member can be configured to couple with the first coupling portion or with the third coupling portions of the carrier plate. For this purpose, the pushing member can engage the recess of the first or each third coupling portion of the carrier plate to couple with the first or each third coupling portion. In other words, the pushing member can comprise at least one coupling portion that can couple with the first coupling portion or each third coupling portion of the carrier plate. Each coupling portion of the pushing member can be configured, for example, as a protrusion that extends downward from the bottom side of the pushing member. For coupling, each protrusion can engage the recess of the corresponding first or third coupling portion. In the coupled state, the pushing member can then push the carrier plate in an insertion direction and pull it against the insertion direction. The insertion direction runs from the transfer plate to the freeze dryer, in particular to the placement plate of the freeze dryer. When the pushing member is used to couple with the first coupling portion of a carrier plate to pull the carrier plate, the carrier plate is arranged in the operating position on the transfer plate such that the first edge side faces away from the freeze dryer. In other words, the first edge side is thereby arranged upstream at the carrier plate in the insertion direction of the carrier plate. When the pushing member is used to couple with the two third coupling portions of a carrier plate to pull the carrier plate, the carrier plate is arranged in the operating position on the transfer plate so that the second edge side faces away from the freeze dryer. In other words, the second edge side is thereby arranged upstream at the carrier plate in the insertion direction of the carrier plate.

In a further refinement, the pushing member of the linear unit is configured such that it can simultaneously push and/or pull two carrier plates that are arranged perpendicular to the insertion direction.

In this way, two carrier plates can be handled simultaneously, thereby increasing efficiency.

In a further refinement, the pushing member can comprise four coupling portions, wherein the four coupling portions are arranged such that they can couple with the third coupling portions of two carrier plates arranged side by side.

For this purpose, the four coupling portions are distributed perpendicularly to the insertion direction along the pushing member at equal intervals. The coupling portions can be, for example, protrusions extending downward from a bottom side of the pushing member. For coupling, each protrusion can engage a corresponding recess of a third coupling portion of the carrier plate.

In a further refinement, the second handling device is vertically movable.

Preferably, for this purpose, the second handling device comprises a drive device, in particular a stroke device, by means of which the pusher is vertically movable. In this way, the second handling device can comprise the pusher at the level of the carrier plate (in particular above the transfer plate) for pushing the carrier plate into the freeze dryer or pulling the carrier plate out of the freeze dryer. The pusher, however, restricts the accessibility to the carrier plate if it is arranged at the level of the carrier plate. Therefore, it is advantageous if the pusher during loading and unloading of the carrier plate with containers is arranged below the carrier plate (in particular below the transfer plate). For this purpose, it can be provided that the pusher is moved to the level of the carrier plate only for inserting and pulling out the carrier plate and, correspondingly, is otherwise moved below the carrier plate (in particular below the transfer plate). For example, the second handling device can be arranged below the transfer plate while inserting the containers by means of the first handling device. After the carrier plate is equipped with containers, the second handling device can be moved above the transfer plate to the level of the carrier plate to couple with the carrier plate. The carrier plate can then be inserted into the freeze dryer. Once the carrier plate is inserted, the second handling device is decoupled from the carrier plate and moved out of the freeze dryer. After freeze-drying, the second handling device is moved back into the freeze dryer again to couple with the carrier plate. The carrier plate can then be pulled out of the freeze dryer until it is arranged on the transfer plate. Then, the second handling device is decoupled from the carrier plate and moved under the transfer plate. Then, the first handling device can remove the containers from the receptacles of the carrier plate again. In this way, the accessibility to the carrier plate during loading and unloading of the carrier plate with containers is improved.

In a further refinement, the second handling device is configured as a stroke-linear unit.

A stroke-linear unit is vertically movable and comprises a member, for example a pusher, by means of which a carrier plate can be pushed or pulled.

In a further refinement, the freeze dryer comprises at least one placement surface for the containers, wherein the containers are pushable onto and/or pullable from the placement surface by means of the second handling device.

Preferably, the freeze dryer comprises one or more placement plates, wherein each placement plate comprises a placement surface. The placement surface is thereby the top side of a placement plate. On the placement surface, one or several carrier plates equipped with containers can be arranged.

In a further refinement, the freeze dryer comprises a plurality of placement surfaces.

Preferably, a freeze dryer comprises several placement plates distributed on several levels of the freeze dryer. As a result, the placement surfaces are also distributed on multiple levels of the freeze dryer. Each placement surface can be arranged on a particular level of the freeze dryer, or can be fixedly arranged.

In a further refinement, the handling station comprises a transfer plate on which the carrier plate is arrangeable in the handling station for loading and unloading.

The transfer plate can also be referred to as a push-over plate. The transfer plate comprises a transfer surface on which the carrier plates can be arranged. The transfer surface is a top side of the transfer plate. On the transfer plate, the carrier plates can be arranged one after another for loading, for example, and equipped with containers. The carrier plates equipped with containers can then be inserted into the freeze dryer. After freeze-drying, the carrier plates can be correspondingly transferred out of the freeze-dryer again onto the transfer plate, where the containers can be removed again.

In a further refinement, the second handling device is configured to push the carrier plate from the placement surface to the transfer surface and/or pull the carrier plate from the placement surface to the transfer surface.

In this way, the carrier plates can be easily inserted into the freeze dryer and removed therefrom again.

In a further refinement, the placement surfaces are vertically movable.

In this way, the placement surfaces can be arranged on different levels of the freeze dryer.

In a further refinement, the placement surfaces are vertically movable such that for inserting and/or removing the carrier plate, one of the placement surfaces can be arranged substantially in one plane with a transfer surface of the transfer plate. In one plane means that an offset between the transfer surface and the placement surface in the vertical direction amounts to only a few millimeters. For example, the offset is less than 5 mm, in particular less than 1 mm.

In other words, the individual placement surfaces can be moved one after another to the level of the transfer plate for loading, so that one or several carrier plates can be pushed from the transfer plate to the respective placement surface. After loading, each placement surface is moved to a specific assigned level of the freeze dryer. For unloading, the placement surfaces are moved again one after another to the level of the transfer surface of the transfer plate, so that the carrier plates can be pulled again from the placement surface onto the transfer plate. For pulling and pushing, the placement surfaces can in particular be arranged such that they are at the same level as the transfer surface of the transfer plate or arranged in alignment with the transfer surface. Alternatively, it can also be provided that the placement surfaces are fixedly mounted on the individual levels of the freeze dryer and that the transfer plate is vertically movable instead. For loading and unloading a placement surface, the transfer plate can then be moved such that the transfer surface is brought to the level of the placement surface.

Preferably, when inserting the carrier plate, the placement surface is arranged lower than the transfer surface, and when removing the carrier plate, the placement surface is arranged higher than the transfer surface. In particular, an offset between the transfer surface and the placement surface in the vertical direction, as previously described, amounts thereby to only a few millimeters. In this way, safe sliding over of the carrier plate is made possible without the carrier plate adhering to an edge of the placement plate or the carrier plate.

In a further refinement, the handling station comprises a carrier plate holder that is configured to hold and/or store a plurality of carrier plates.

The carrier plates are arranged for storing in the carrier plate holder without received containers. For this purpose, the carrier plate holder can comprise individual holders or receptacles for the carrier plates. If a carrier plate is required for loading the freeze dryer, it can be removed from the carrier plate holder and equipped with containers. In other words, the carrier plate holder offers the possibility to hold the carrier plate in front so that a carrier plate can be removed when needed. Correspondingly, after freeze-drying, the emptied carrier plates are transferred back into the carrier plate holder. The carrier plate holder thus allows a quick accessibility to or placement of carrier plates.

In a further refinement, a third handling device of the at least one handling device is configured to transfer a carrier plate between the carrier plate holder and the transfer plate.

In this way, by means of the third handling device, the carrier plates can be provided for loading and, after unloading, can be stored again in the carrier plate holder. In particular, the third handling device is configured to remove the carrier plate from the carrier plate holder, transfer it to the transfer plate and arrange it on the transfer plate and/or receive it from the transfer plate, transfer it to the carrier plate holder and arrange or place it in the carrier plate holder.

In a further refinement, each carrier plate comprises at least one coupling portion and the third handling device comprises a receiving device, wherein the receiving device is couplable with the coupling portion of one of the carrier plates so that the third handling device can transfer, in particular lift, lower and move horizontally, the carrier plate in the coupled state. The coupling portion of the carrier plate can in particular be the first coupling portion. Alternatively, the at least one coupling portion can also comprise the third coupling portions of the carrier plate.

In the coupled state, the handling device can handle a coupled carrier plate, in particular move it between the carrier plate holder and the transfer plate. The third handling device is preferably a handling robot that is configured for handling the carrier plate. The handling robot can comprise an end effector for handling the carrier plate. The handling robot can comprise a multi-jointed arm at the end of which the end effector can be arranged, wherein the end effector is movable in space by means of the arm. The end effector of the handling robot can comprise the receiving device. For moving the arm, drive means, such as one or more drive devices, can be provided. The arm can be fixed to a support structure arranged in or at the handling station. The reach of the arm is preferably such that the end effector is movable between the transfer plate and the carrier plate holder. When the receiving device is used to couple with the first coupling portion of a carrier plate to transfer the carrier plate, the carrier plate in the operating position is arranged in the carrier plate holder such that the first edge side is oriented upwardly. When the receiving device is used to couple with the two third coupling portions of a carrier plate to transfer the carrier plate, the carrier plate is arranged in the operating position in the carrier plate holder such that the second edge side is oriented upwardly.

In a further refinement, the receiving device of the third handling device comprises at least one receiving member, wherein the first or each third coupling portion of the carrier plate is engageable with the corresponding receiving member for coupling.

In this way, the carrier plate can be easily coupled with the third handling device. Each receiving member is preferably hook-shaped or configured as a hook, wherein the receiving member hooks with the first coupling portion, in particular with the holding member, of the carrier plate for coupling. In other words, each receiving member comprises at least one coupling portion that can be engaged with the corresponding first or third coupling portion of the carrier plate to couple the receiving device with the carrier plate. Each coupling portion of the receiving member can be configured as a hook-shaped receptacle, for example. In this way, the third handling device can lift, transfer, and place the carrier plate.

In a further refinement, the holding member of the first or each third coupling portion of the carrier plate is configured such that the corresponding receiving member can be engaged with the holding member of the first or each third coupling portion of the carrier plate to couple the handling device with the carrier plate.

In this way, the carrier plate is easily coupled with the handling device so that the handling device can move the carrier plate. The holding member of the first or each third coupling portion of the carrier plate is preferably configured such that the corresponding receiving member can engage the recess of the holding member of the first or each third coupling portion of the carrier plate to couple the handling device with the carrier plate. In particular, each receiving member is hooked with the corresponding holding member for coupling.

In a further refinement, the first and third handling devices are configured by a handling robot, in particular wherein the handling robot comprises an end effector that comprises the gripping device of the first handling device and the receiving device of the third handling device.

In this way, installation space is saved since the first and third handling devices are configured by means of a single handling robot that comprises, for example, two different tools at its end effector. Thereby, the gripping device can be arranged on one side of the end effector and the receiving device can be arranged on a second side of the end effector opposite to the first side. The end effector can be rotatably mounted at the multi-jointed arm of the handling robot, whereby the orientation of the tool to be used (i.e., gripping or receiving device) is adjustable accordingly.

In a further refinement, the feeding of the containers comprises the following steps:
transporting the containers to a container holder of the handling station by means of a transport device; and
arranging the fed containers in the container holder.

The transport device can be configured to feed the containers to the handling station and remove the freeze-dried containers from the handling station. Alternatively, two different transport devices can also be provided, wherein a first transport device is configured to feed the containers to the handling station and a second (further) transport device is configured to remove the freeze-dried containers from the handling station. The transport device(s) thus provide a feeder or remover for the containers to/from the handling station, wherein the containers are arranged in the container holder. For example, the transport device(s) can feed the containers from an upstream filling module with filling station and stopper placing station to the handling station. Furthermore, the transport device(s) can remove the containers from the handling station to a downstream crimping module with crimping station. In the container holder, fed containers or containers to be transported away can be temporarily stored or collected. The container holder is thus an intermediate storage place between the feeder (in particular the transport device) and the first handling device.

In a further refinement, the containers are transported individually or several containers are transported together, in particular in pairs, by means of the transport device.

For this purpose, the transport device can comprise a handling robot that is configured to receive the containers individually or in pairs from an upstream filling module for feeding and to transfer them to the handling station (in particular to a container holder in the handling station described in the following). Correspondingly, the handling robot of the transport device or the further transport device can be configured to transfer the containers individually or in pairs from the handling station (in particular from a container holder in the handling station described in the following) to a crimping module arranged downstream for removing and to transfer the containers to the crimping module. For handling the containers, the handling robot can comprise a gripping device by means of which one or several containers can be gripped simultaneously. For example, the handling robot can comprise an end effector, wherein the gripping device is arranged at the end effector. The end effector can comprise the gripping device or support the gripping device. The handling robot preferably comprises a multi-jointed arm, at the end of which the end effector is arranged. The arm thus carries the end effector. The end effector can be moved in space by means of the arm. For moving the arm, drive means, such as one or more drive devices, can be provided. The arm can be fixed to a support structure that is arranged in or at the handling station. The reach of the arm is preferably such that the end effector is movable between the handling station and the filling module and/or the crimping module in order to be able to transfer the containers between the handling station and the filling module or between the handling station and the crimping module.

In a further refinement, the container holder comprises a plurality of receptacles, wherein the containers are inserted into the receptacles for arranging the containers in the container holder.

In this way, a plurality of containers can be collected or temporarily stored in the container holder.

In a further refinement, the inserting of the containers into corresponding receptacles of the carrier plate by means of the first handling device comprises the following steps:
removing one or several containers, in particular a row of containers, from the container holder;
transferring the removed containers to the carrier plate; and
inserting the transferred containers into empty receptacles of the carrier plate.

In this way, the first handling device can remove the fed and temporarily stored containers from the receptacles of the container holder and insert them into or arrange them in the receptacles of the carrier plate.

In a further refinement, the carrier plate is arranged on a transfer plate in the handling station for loading and/or unloading.

The transfer plate can also be referred to as a push-over plate. The transfer plate comprises a transfer surface on which the carrier plates can be arranged. The transfer surface is a top side of the transfer plate. On the transfer plate, the carrier plates can be arranged one after another for loading, for example, and equipped with containers. The carrier plates equipped with containers can then be inserted into the freeze dryer. After freeze-drying, the carrier plates can be correspondingly transferred out of the freeze-dryer again onto the transfer plate, where the containers can be removed again.

In a further refinement, in the step of inserting the carrier plate into the freeze dryer, the carrier plate is inserted by means of the second handling device from the handling device into the freeze dryer.

In particular, the carrier plate is thereby pushed from a transfer plate of the handling station onto a placement surface of the freeze dryer. In this way, the carrier plates can be easily inserted into the freeze dryer.

In a further refinement, the providing of the carrier plate comprises the following steps:
Arranging a plurality of carrier plates in a carrier plate holder of the handling station; and
Transferring the carrier plate from the carrier plate holder to the transfer plate by means of a third handling device.

The carrier plates are arranged for storing in the carrier plate holder without received containers. For this purpose, the carrier plate holder can comprise individual holders or receptacles for the carrier plates. If a carrier plate is required for loading the freeze dryer, it can be removed from the carrier plate holder and equipped with containers. In other words, the carrier plate holder offers the possibility to hold the carrier plate in front so that a carrier plate can be removed when needed. Correspondingly, after freeze-drying, the emptied carrier plates are transferred back into the carrier plate holder. The carrier plate holder thus allows a quick accessibility to or placement of carrier plates. By means of the third handling device, the carrier plates can be provided for loading and after unloading can be stored again in the carrier plate holder. In particular, the third handling device is configured to remove the carrier plate from the carrier plate holder, transfer it to the transfer plate and arrange it on the transfer plate and/or receive it from the transfer plate, transfer it to the carrier plate holder and arrange or place it in the carrier plate holder.

In a further refinement, each carrier plate comprises a coupling portion and the handling device comprises a receiving device that is couplable with the coupling portion, wherein the providing of the carrier plate further comprises the following steps:
coupling the third handling device with one of the carrier plate arranged in the carrier plate holder prior to the step of the transferring; and
decoupling the third handling device from the carrier plate after the step of transferring.

In the coupled state, the handling device can handle a coupled carrier plate, in particular move it between the carrier plate holder and the transfer plate.

In a further refinement, the step of providing alternatively comprises the following steps:
arranging the carrier plate in the freeze dryer, in particular on a placement surface of the freeze dryer; and
removing the carrier plate from the freeze dryer by means of the second handling device, in particular wherein the carrier plate is pulled from the placement surface onto the transfer plate.

In this way, the carrier plates can be temporarily stored empty in the freeze dryer, for example, and removed from the freeze dryer for equipping with containers. In this way, the area of the loading system is cleared so as not to overly affect the laminar flow stream.

In a further refinement, the method comprises the following steps for unloading the freeze dryer:
removing the carrier plate from the freeze dryer by means of the second handling device;
removing the containers from the receptacles of the carrier plate in the handling station by means of the first handling means; and
removing the containers from the handling station by means of the transport device or a further transport device.

In this way, the freeze dryer can be unloaded again after the freeze-drying.

In a further refinement, in the step of removing the carrier plate from the freeze dryer, the carrier plate is pulled out of the freeze dryer by means of the second handling device.

In particular, the carrier plate is pulled from the placement surface onto the transfer plate of the handling station. In this way, the carrier plates can be easily removed again from the freeze dryer.

In a further refinement, the removing of the containers from the receptacles of the carrier plate by means of the first handling device comprises the following steps:
removing one or several containers, in particular a row of containers, from the receptacles of the carrier plate;
transferring the removed containers to the container holder; and
inserting the transferred containers into the container holder.

In this way, the first handling device can remove the freeze-dried containers from the receptacles of the carrier plate and place or arrange them in the receptacles of the container holder for temporary storage prior to the removal. In this way, the containers to be transported away can be collected in the container holder prior to being transported away.

In a further refinement, the removing of the containers from the container holder comprises:
removing the containers from the container holder; and
transporting the containers away by means of the transport device or a further transport device.

As previously described, the transport device is configured at least to feed the containers to the handling station. Either the transport device or a further transport device can be configured to remove the freeze-dried containers from the handling station. The transport device(s) thus provide a feeder or remover for the containers to/from the handling station. For example, the transport device(s) can feed the containers from an upstream filling module with filling station and stopper placing station to the handling station. Furthermore, the transport device(s) can remove the containers from the handling station to a downstream crimping module with crimping station.

In a further refinement, the method comprises, after the step of removing the containers from the receptacles of the carrier plate, furthermore the following step:

- storing the carrier plate in the carrier plate holder.

In this way, the carrier plates can be arranged in the carrier plate holder again after their use, in order to store them until their next use.

In a further refinement, the storing of the carrier plate in the carrier plate holder comprises the following steps:
transferring the carrier plate from the transfer plate to the carrier plate holder by means of the third handling device; and
arranging the transferred carrier plate in the carrier plate holder.

In this way, by means of the third handling device, the carrier plates can be stored again in the carrier plate holder after unloading. In particular, the third handling device is configured to receive the carrier plate from the transfer plate, transfer it to the carrier plate holder, and arrange or place it in the carrier plate holder.

In a further refinement, each carrier plate comprises a coupling portion and the handling device comprises a receiving device that is couplable with the coupling portion, wherein the storing of the carrier plate further comprises the following steps:
coupling the third handling device with a carrier plate arranged on the transfer plate prior to the step of transferring; and
decoupling the third handling device from the transferred carrier plate after the step of transferring.

In the coupled state, the handling device can handle a coupled carrier plate, in particular move it between the carrier plate holder and the transfer plate.

In a further refinement, the method comprises, after the step of removing the containers from the receptacles of the carrier plate, alternatively the following steps:
inserting the emptied carrier plate into the freeze dryer by means of the second handling device, in particular wherein the carrier plate is pushed from the transfer plate onto the placement surface of the freeze dryer; and
storing the carrier plate in the freeze dryer.

As a result, the emptied carrier plates can be temporarily stored in the freeze dryer. In this way, the area of the loading system is cleared so as not to overly affect the laminar flow stream.

It is understood that the above features and those to be explained below can be used not only in the combination indicated in each case, but also in other combinations or on their own, without departing from the scope of the present invention.

### DRAWINGS

Embodiments of the invention are shown in the drawings and are explained in more detail in the following description. Showing:

FIG. 1 a schematic view of a first embodiment of a loading system for a freeze dryer;

FIG. 2 an isometric view of a second embodiment of a loading system for a freeze dryer;

FIGS. 3-36 are detailed views of the loading system of FIG. 2 in various operating conditions;

FIG. 37 is a schematic view of an embodiment of a method for handling containers in a loading system for a freeze dryer;

FIG. 38 is a schematic view of the loading of the freeze dryer step in the method of FIG. 37;

FIG. 39 is a detailed view of the providing step in FIG. 38;

FIG. 40 is a detailed view of the feeding step in FIG. 38;

FIG. 41 is a detailed view of the inserting step in FIG. 38;

FIG. 42 is a schematic view of the unloading of the freeze dryer step in the method of FIG. 37;

FIG. 43 is a detailed view of the unloading step in FIG. 42;

FIG. 44 is a detailed view of the removing step in FIG. 42;

FIG. 45 is a detailed view of the storing step in FIG. 42;

FIG. 46 is an isometric view of a third embodiment of a loading system for a freeze dryer; and

FIGS. 47- 63 are detailed views of the loading system of FIG. 46 in various operating conditions.

### DETAILED DESCRIPTION

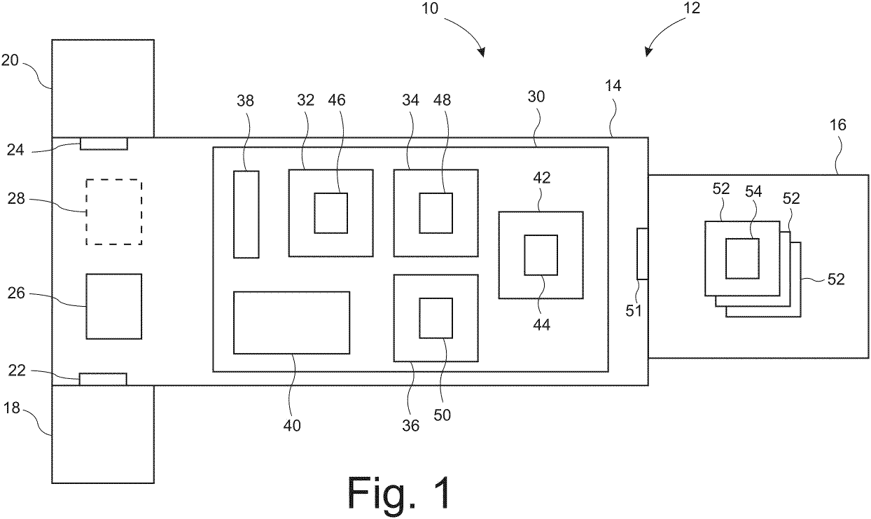

FIG. 1 shows a first embodiment of a loading system 10 for a freeze dryer 16. The loading system 10 is part of a freeze-drying system 12 that comprises the loading system 10 and the freeze dryer 16. The freeze-drying system 12 can be part of a packaging machine in which pharmaceutical or cosmetic substances are packaged in containers 114.

For this purpose, the packaging machine comprises a filling module 18, a freeze-drying module 14, and a crimping module 20. The filling module 18 can comprise a filling station, in which the containers are filled with the substance, and a stopper placing station, in which a stopper is placed on the containers. The crimping module 20 can comprise a crimping station in which each container is closed with a crimping cap. The entire packaging process of the substances is performed in an aseptic environment, for example in a clean room or ultraclean room.

Freeze-drying module 14 is coupled with the freeze dryer 16 via a port 51. The loading system 10 is arranged in the freeze-drying module 14. By means of the loading system, containers can be inserted into the freeze dryer through the port 51 and removed from the freeze dryer after the freeze-drying.

The freeze-drying system 12 can comprise the freeze-drying module 14. The freeze-drying module 14 is arranged between the filling module 18 and the crimping module 20. By means of a first transfer station 22, containers can be transferred between the filling module 18 and the freeze-drying module 14. By means of a second transfer station 24, containers can be transferred between the freeze-drying module 14 and the crimping module 20.

For feeding the containers from the filling module 18 and for removing the containers into the crimping module 20, the freeze-drying module 14 comprises at least one transport device 26, 28. For example, the freeze-drying module 14 comprises a first transport device 26 for feeding the containers and a second transport device 28 for removing the containers. Alternatively, only the first transport device 26 can be provided, wherein the first transport device 26 then performs the feeding and removing of the containers. During the feeding and removing, the containers can, for example, be transferred between the modules 14, 18, 20 via the transfer stations 22, 24.

At least one of the transport devices 26, 28 can be configured, for example, as a handling robot that comprises a gripping tool for handling containers. Alternatively, the transport devices 26, 28 can also be configured in other ways to feed or remove the containers. For example, at least one of the transport devices 26 can also be configured as a transport belt or other type of conveyor technology to feed or remove the containers.

The loading system 10 comprises a handling station 30. The handling station 30 is arranged between the transport devices 26, 28 and the freeze dryer. The handling station 30 is in particular arranged next to the port 51.

The handling station 30 comprises a first handling device 32, a second handling device 34, a third handling device 36, a container holder 38, a carrier plate holder 40, and a transfer plate 42.

The container holder 38 comprises receptacles for containers, in which containers can be received respectively individually. For feeding the containers, the first transport device inserts the containers to be fed into the container holder 38. For removing the containers, the first transport device 26 or the second transport device 28 removes containers to be removed from the container holder 38.

The carrier plate holder 40 comprises receptacles or holders for carrier plates. The carrier plates serve as carriers for a plurality of containers. For this purpose, each carrier plate comprises a plurality of receptacles, each of which is configured to receive a container.

The transfer plate 42 comprises a transfer surface 44. The transfer surface 44 is a top side of the transfer plate 42. The transfer surface 44 is preferably oriented horizontally. On the transfer surface 44, the carrier plates are arranged for loading and unloading the freeze dryer. For loading the freeze dryer 16, the carrier plates are arranged one after another on the transfer plate 42, equipped with containers and then inserted into the freeze dryer 16. For unloading the freeze dryer 16, the carrier plates are taken out of the freeze dryer 16 one after another, arranged on the transfer plate 42 and the containers are removed.

The freeze dryer 16 comprises a plurality of placement plates 52. Each placement plate 52 comprises a placement surface 54 on which one or more carrier plates can be arranged, in particular placed. Each placement surface 54 is the top side of a corresponding placement plate 52. The placement plates 52 can be vertically movable. For this purpose, the freeze dryer 16 can comprise a drive device which can move the placement plates 52 vertically.

Preferably, the transfer plate 42 is arranged at the port 51. Between the transfer plate 42 and the placement plate 52, a gap can be arranged. To keep the gap as small as possible, the transfer plate 42 and the placement plate 52 can be arranged as close as possible to the port. The gap is preferably smaller than half the width of the carrier plate. In this way, it is achieved that when inserting and removing the carrier plate, the carrier plate always rests on the placement surface and on the transfer surface when the center of gravity of the carrier plate is arranged above the gap.

The first handling device 32 is configured to transfer the containers between the container holder 38 and the transfer plate 42. For example, the handling device 32 can remove the fed containers from the container holder 38, transfer them to the transfer plate 42, and insert them into receptacles of a carrier plate arranged on the transfer plate 42. Furthermore, the handling device 32 can remove the containers to be removed from the receptacles of a carrier plate arranged on the transfer plate 42, transfer them to the container holder 38, and insert them therein.

The first handling device 32 can comprise a gripping device 46 for handling the containers. The gripping device 46 is configured to grip the containers. For example, the handling device 32 can be configured as a handling robot that comprises a multi-jointed arm and an end effector, wherein the end effector is arranged at an end of the arm. The gripping device can be arranged at the end effector.

The second handling device 34 is configured to insert the carrier plates into the freeze dryer 16 and to remove them from the freeze dryer 16 again after the freeze-drying. In other words, the handling device 34 is configured to transfer the carrier plates between the transfer plate 42 and the freeze dryer 16. The handling device 34 can, for example, insert one or several carrier plates from the transfer plate 42 onto one of the placement surfaces 54 to insert the carrier plates into the freeze dryer. The handling device 34 can furthermore pull one or several carrier plates from a placement surface 54 onto the transfer plate 42 to remove or retrieve the carrier plates from the freeze dryer. Prior to the insertion or removal, the corresponding placement surface is transferred to the level of the transfer surface 44 so that the carrier plates can be moved or pulled planarly. Preferably, when inserting the carrier plate, the placement surface 54 is arranged lower than the transfer surface 44, and when removing the carrier plate, the placement surface 54 is arranged higher than the transfer surface 44. In particular, thereby an offset between the transfer surface 44 and the placement surface 54 in the vertical direction is only a few millimeters. For example, the offset can be less than 5 mm, in particular less than 1 mm. In particular, the offset can be 0.25 mm, 0.5 mm, 0.75 mm, 0.9 mm, 1 mm, 2 mm, 3 mm, 4 mm or 5 mm.

The second handling device 34 can comprise a linear unit 48 for handling the carrier plates. The linear unit 48 is configured to move the carrier plates horizontally, in particular to push and pull them. Preferably, the second handling device 34 can push and pull several carrier plates simultaneously.

The third handling device 36 is configured to transfer the carrier plates between the carrier plate holder 40 and the transfer plate 42. For example, the handling device 36 can remove a respective carrier plate from a receptacle of the carrier plate holder 40, transfer it to the transfer plate 42, and place it on the transfer surface 44. Furthermore, the third handling device 36 can lift a respective carrier plate from the transfer plate 42, transfer it to the carrier plate holder 40, and place it in a receptacle of the carrier plate holder 40. Furthermore, the third handling device 36 can displace the carrier plate on the transfer plate 42 to position the carrier plate on the transfer surface 44.

The third handling device 36 can comprise a receiving device 50 for handling a carrier plate. The receiving device 50 can comprise at least one receiving member that can couple with the carrier plate to be handled in order to move the carrier plate.

The loading system 10 can comprise a control device (not shown) that is configured to control the handling devices 32, 34, 36. The control device can also be configured to control the transport devices 26, 28 and the drive device of the freeze dryer 16.

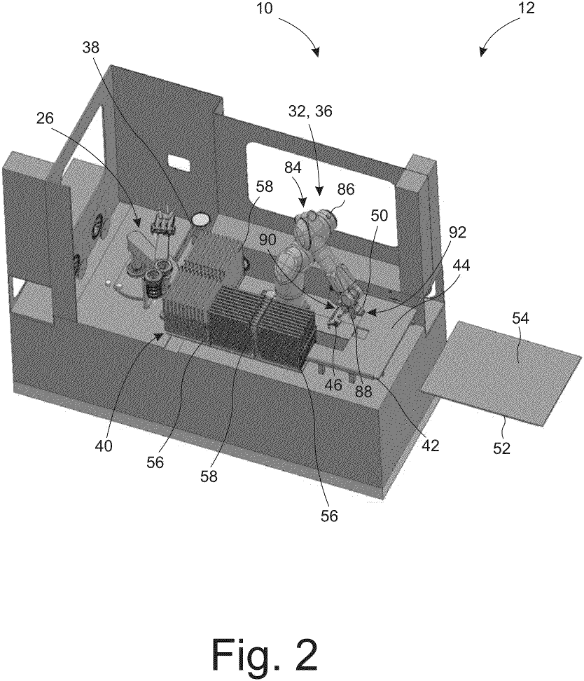

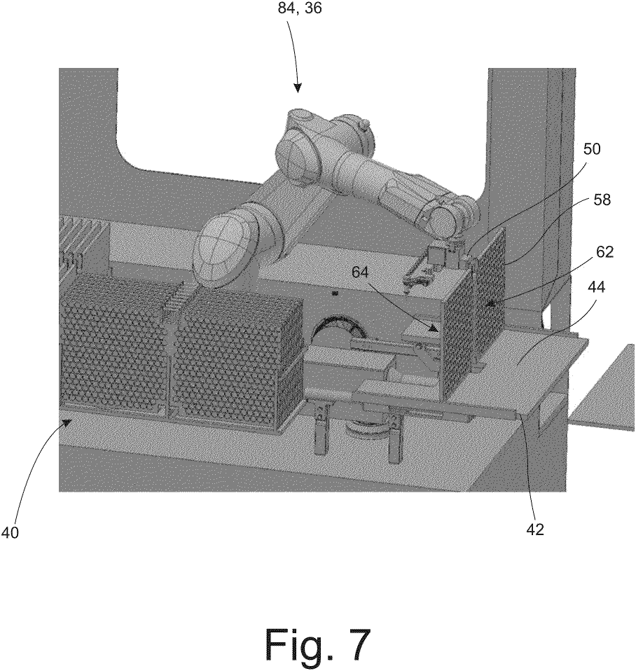

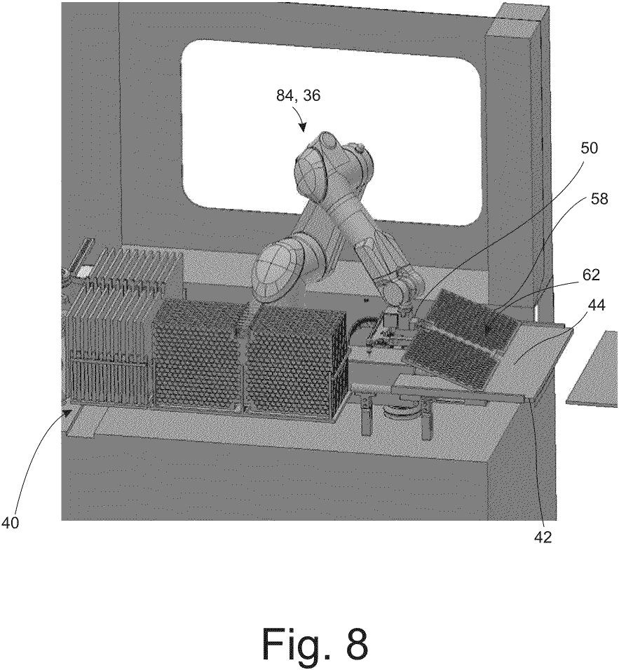

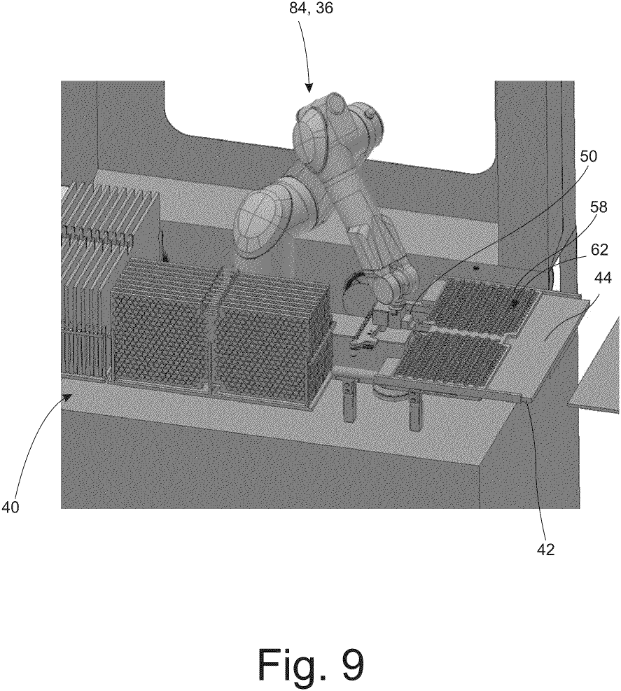

FIGS. 2 to 36 show a second embodiment of the loading system 10. The loading system 10 is shown in FIGS. 2 to 36 in various operating positions. The loading system 10 of the second embodiment corresponds substantially to the loading system 10 of the first embodiment of FIG. 1. The same elements are identified by the same reference signs and are not explained in further detail.

In the loading system 10, carrier plates 58 are used to load or unload the freeze dryer 16 with containers 114. The containers 114 have a cylindrical shape. In other words, the containers 114 are configured to be rotationally symmetrical with respect to an axis. The containers 114 comprise, in an axial direction with respect to the axis, a bottom on one side and an opening on the other side. On the opening of the containers 114, a stopper can be arranged. During the handling in the loading system 10, the containers 114 are handled such that the opening is arranged upwardly with respect to a vertical direction and the bottom is arranged downwardly.

Each carrier plate 58 is configured to be cuboid-shaped. Each carrier plate 58 has a rectangular base surface. Each carrier plate 58 comprises a first side surface 62 and a second side surface 64. The first side surface 62 is arranged opposite the second side surface 64. The first and the second side surfaces 62, 64 are arranged parallel to each other. The side surfaces 62, 64 extend in the length and width direction of the carrier plate 58. The shape of each side surface 62, 64 thus corresponds to the shape of the base surface of the carrier plate 58. The side surfaces 62, 64 thus each have a rectangular shape. A distance between the first side surface 62 to the second side surface 64 thus corresponds to the thickness of the carrier plate 58. The thickness of the carrier plate 58 is substantially smaller than the length and width of the carrier plate 58. Each carrier plate 58 comprises a plurality of receptacles 60 on the first side surface 62. Each receptacle 60 is configured to receive a respective container. The receptacles are configured as recesses on the first side surface 62 of the carrier plate 58. Each recess comprises the same depth. Each recess extends from the first side surface 62 toward the second side surface 62. The recesses, however, do not extend to the second side surface 64. In other words, a depth of the recesses is less than a distance of the first side surface 62 to the second side surface 64. The receptacles 60 are regularly distributed on the first side surface 62. In particular, the receptacles 60 are arranged in rows and comprise the same distance to adjacent receptacles 60.

The first side surface 62 is divided in the length direction into two equally sized areas. The areas are preferably square. In each area, the rows of receptacles 60 are arranged one after the other in the width direction of the carrier plate 58. Each row extends in the length direction.

In the operating state, that is, when a carrier plate 58 is received on the transfer plate 42 or on one of the placement plates 52, the first side surface 62 corresponds to the top side of the carrier plate 58. Correspondingly, the second side surface 64 corresponds to the bottom side of the carrier plate 58 in the operating state. In the operating state, the containers 114 can be inserted into the receptacles 60. The inserted containers 114 then stand in the recesses of the receptacles 60 and are held by the edge of each receptacle 60 in the respective receptacle 60.

Each carrier plate 58 furthermore comprises a first edge side 70 and a second edge side 72. The first edge side 70 is arranged opposite to the second edge side 72. The first and second edge sides 70, 72 each extend from the first side surface 62 to the second side surface 64. In particular, the first and second side surfaces 62, 64 are arranged perpendicular to the first and second edge sides. The first and second edge sides 70, 72 extend in the length and height direction of the carrier plate 58. Each carrier plate 58 comprises a first coupling portion 66 and a second coupling portion 68. The first coupling portion 66 is arranged on the first edge side 70 of the carrier plate 58. The second coupling portion 68 is arranged on the second edge side 72 of the carrier plate 58. The first and second coupling portions 66, 68 are each arranged centrally with respect to the longitudinal direction on the corresponding edge side 70, 72.

The first coupling portion 66 of a carrier plate 58 can couple with a coupling portion of another object. The coupling portion of the other object can be, for example, the second coupling portion 68 of an adjacent carrier plate 58. In the coupled state, the carrier plate 58 and the object coupled thereto are movable together in at least one spatial direction. For example, coupled carrier plates 58 can be handled together.

The first coupling portion 66 comprises a holding member 74 and a recess 76. The holding member 74 is configured as a web that extends from one side of the recess 76 to an opposite side of the recess 76. The web is preferably arranged parallel to the first and second side surfaces 62, 64 and parallel to the first and second edge sides 70, 72. The web is preferably arranged at an outer end of the recess 76. A corresponding member of another object can couple with the holding member 74 to couple the carrier plate 58 with the other object. For example, the member can engage with the recess 76 to couple with the holding member 74.

The second coupling portion 68 comprises a locking member 78. The locking member 78 can be a hook member that is rotatably mounted at the coupling portion 66 for rotation about a rotational axis. The rotational axis is preferably arranged parallel to the first and second side surfaces 62, 64 as well as parallel to the first and second edge sides 70, 72. Thus, the rotational axis is also arranged parallel to the web of the holding member 74 of the same carrier plate 58. The locking member 78 can be displaced between a coupling state and an uncoupling state. The displacement is achieved by rotation about a rotational axis.

In the coupling state, the second coupling portion 68 can couple with a first coupling portion 66 of a further carrier plate 58. In the uncoupling state, the second coupling portion 68 does not couple with a first coupling portion 66 of a further carrier plate 58. For coupling two carrier plates 58, the carrier plates 58 are arranged such that the second coupling portion 66 of the first carrier plate 58 is adjacent to the first coupling portion 68 of the second carrier plate 58, wherein the locking member 78 of the first carrier plate 58 is arranged in the uncoupling state. Then, this locking member 78 is moved to the coupling state to couple the carrier plates 58 with each other. Thereby, the locking member 78 of the first carrier plate 58 engages the recess 76 of the second carrier plate 58 and thereby couples with the holding member 74 of the second recess. The hook-shaped locking member 78 preferably extends on both sides of the rotational axis, wherein the locking member 78 comprises a hook portion on one side and an actuating portion on the other side. The hook portion comprises, for example, a hook-shaped receptacle. By means of the hook portion, the locking member 78 can couple. In particular, the hook-shaped receptacle can receive the holding member 74 of the first coupling portion 66 for coupling. By means of the actuating portion, the locking member 78 can be actuated. By actuating the actuating portion, the locking member 78 is rotated about a rotational axis to displace the locking member 78 between the coupling state and the uncoupling state. For example, the actuating portion can be pressed for actuation.

In the operating state, the locking member 78 as an initial state, preferably due to gravity, can be arranged in the coupling state. In the operating state, preferably the hook-shaped receptacle of the hook portion of the locking member 78 is oriented downward. For coupling with a further carrier plate 58, the locking member 78 must then first be moved to the uncoupling state, preferably against the force of gravity, so that the respective coupling portions 66, 68 can be arranged adjacent to each other for coupling. Thereby, the hook-shaped receptacle of the hook portion of the locking member 78 is moved upwardly. For moving to the uncoupling state, the actuating portion of the locking member 78 can be actuated.

The locking member 78 can also comprise a flank at the radially outer end of the hook portion. By actuation of the flank, the locking member 78 can be moved from the coupling state to the uncoupling state. For example, for arranging the coupling portions 66, 68 side by side, the carrier plates 58 can be moved toward each other so that the holding member 74 is moved toward the locking member 78. The holding member 74 can actuate the flank of the locking member 78 during this relative movement of the carrier plates 58 to move the locking member 78 to the uncoupling state. In other words, the locking member 78 swerves due to a pushing movement of the holding member 74 in a rotational direction about a rotational axis in the direction of the uncoupling state. As soon as the carrier plates 58 are adjacent to each other, i.e., when the holding member 74 has passed the flank, the locking member 78 can be moved back to the coupling state to couple the carrier plates 58 to each other. Preferably, the locking member 78 automatically returns to the coupling state due to gravity when the holding member 74 has passed the flank.

For releasing the coupling of two carrier plates 58, the corresponding locking member 78 is again moved into the uncoupling state. For this purpose, the actuating portion of the locking member 78 can be actuated again, for example.

The container holder 38 comprises a plurality of receptacles 102. Each receptacle 102 is configured to receive a respective container 114. The receptacles 102 are arranged in a row. The receptacles 102 are arranged at regular distances.

The carrier plate holder 40 comprises a plurality of holders or receptacles 56 in which the carrier plates 58 can be held. In each receptacle 56, a carrier plate 58 can be held. The receptacles 56 are configured such that the receptacles 56 are open upwardly in the vertical direction and closed downwardly. Closed means that the carrier plates 58, when they are arranged in a receptacle 56, rest on at least one support member at the lower end of the receptacle 56. In particular, the receptacles 56 are configured such that the carrier plates 58 are received in the receptacles 56 such that the side surfaces 62, 64 are arranged parallel to the vertical direction. As a result, the carrier plates 58 can be arranged in the receptacles such that the first edge side 70 is arranged on the top and the second edge side 72 is arranged on the bottom. In this way, the first coupling portion 66 is accessible from above.

In the loading system 10 of the second embodiment, the first handling device 32 and the third handling device 36 are configured by means of a handling robot 84. The handling robot 84 comprises a support structure 86 and an end effector 88 mounted thereto. The support structure 86 is configured as a multi-jointed arm. By means of the multi-jointed arm, the end effector 88 is movable in three spatial directions, i.e. horizontally and vertically.

The end effector 88 comprises the gripping device 46 of the first handling device 32 and the receiving device 50 of the third handling device 36. The gripping device 46 is arranged at a first side 90 of the end effector 88. The receiving device 50 is arranged on a second side 92 of the end effector 88. The first side 90 and the second side 92 are arranged on opposite sides of the end effector 88.

The gripping device 46 is configured to transfer respective one or several containers 114 between the container holder 38 and the transfer plate 42, in particular a carrier plate 58 arranged on the transfer plate 42. For this purpose, the gripping device comprises a plurality of gripping members. Each gripping member is configured to grip a respective container. The gripping members of the gripping device 46 are arranged in a row. The gripping members are arranged at regular distances. By means of the gripping members, the gripping device can remove a row of containers 114 from the receptacles 102 of the container holder 38 and insert them into empty receptacles 60 of the carrier plate 58. Thereby, the distance between adjacent gripping members is equal to the distance between adjacent receptacles 102 and equal to a distance between adjacent receptacles 60.

The receiving device 50 is configured to handle a respective carrier plate 58. For handling, the receiving device 50 comprises a receiving member 80. The receiving member 80 comprises a coupling portion 82, by means of which the receiving device 50 is couplable with the first coupling portion 66 of a carrier plate 58. In the coupled state, third handling device 36 can handle the carrier plate 58 by means of the receiving device 50. Preferably, the third handling device 36 can move the carrier plate 58 horizontally and vertically, in particular lift, lower and displace it on a surface.

The receiving member 80 is configured hook-shaped in the area of the coupling portion 82. In other words, the receiving member 80 comprises a hook-shaped receptacle in the area of the coupling portion 82. In the operating state, the hook-shaped receptacle is open upwardly. For coupling with the first coupling portion 66 of a carrier plate 58, the hook-shaped receptacle can receive the holding member 74 of the first coupling portion 66 of the carrier plate 58. By means of this coupling, the carrier plate 58 can be moved vertically, in particular lifted and lowered, as well as moved or transferred horizontally. When the carrier plate 58 is fully lifted, the side surfaces 62, 64 of the carrier plate 58 are vertically oriented and the first and second edge sides 70, 72 are correspondingly horizontally oriented, wherein the first edge side 70 is arranged at the top and the second edge side 72 is arranged at the bottom.

On the side of the receiving member 80 opposite to the hook-shaped receptacle, the receiving member 80 can additionally comprise a protrusion which can engage the recess 76 of a carrier plate 58 in order to couple the receiving device 50 with the carrier plate 58. By means of this coupling, the carrier plate 58 can be moved, in particular pulled or pushed, when the carrier plate 58 in the operating state rests on a surface, in particular on the transfer surface 44 or on one of the placement surfaces 54.

The second handling device 34 is configured as a handling robot 104. The handling robot 104 comprises the linear unit 48 and a stroke unit 106. In other words, the handling robot 104 is configured as a stroke and linear unit. The linear unit 48 is configured to move the carrier plates 58 horizontally, in particular to push and pull them. In particular, the linear unit 48 can push the carrier plates 58 in an insertion direction from the transfer plate 42 onto one of the placement plates 52 and, correspondingly, pull them back from the placement plate 52 onto the transfer plate 42 against the insertion direction. For this purpose, the linear unit 48 comprises a pushing member 108. The linear unit 48 is configured to move the pushing member 108 back and forth in a, preferably horizontal, direction. The pushing member 108 is thereby extended in the direction of the freeze dryer, or retracted in the opposite direction. In other words, the pushing member 108 can push or pull the carrier plates 58 by means of this movement. The stroke unit 106 is configured to move the linear unit 48 vertically. In this way, the height at which the linear unit 48 performs the pushing or pulling movement can be adjusted.

For moving the carrier plate 58, the pushing member 108 can be placed against the first or second edge side 70, 72 and then push the carrier plate 58 in the corresponding direction. In this way, the pushing member can pull or push the carrier plate 58. The carrier plate 58 is pushed when the carrier plate 58 is moved away from the linear unit 48. This occurs, for example, during the inserting of the carrier plate 58 into the freeze dryer. Thereby, the pushing member 108 can push against the first edge side 70 and thus push the carrier plate 58 into the freeze dryer. Correspondingly, the carrier plate 58 is pulled when the carrier plate 58 is moved toward the linear unit 48. This occurs, for example, during the removing of the carrier plate 58 from the freeze dryer. Thereby, the pushing member 108 can push against the second edge side and thus pull the carrier plate 58 out of the freeze dryer.

Additionally, the pushing member 108 can comprise a coupling portion 110 by means of which the pushing member 108 is couplable with the first coupling portion 66 on the first edge side 70 of a carrier plate 58. In the coupled state, the pushing member 108 can then also pull the carrier plate 58. In this way, the pushing member does not need to be moved to the second edge side 72 for pulling. The pushing member 108 can comprise, for example, a protrusion extending vertically downward as the coupling portion 110. The protrusion can be engaged with the recess 76 so that the protrusion engages the holding member 74 during pulling. The protrusion is engaged with or disengaged from the recess 76 by means of a vertical movement. The vertical movement is performed by means of the stroke unit 106.

The protrusion of the pushing member 108 can also be used to actuate the actuating portion of the locking member 78 of the second coupling portion 68. For this purpose, the pushing member can be vertically moved by means of the stroke unit 106 such that the protrusion presses on the actuating portion, to thus relocate the locking member 78 to the uncoupling state. With two coupled carrier plates 58, the coupling can thus be released by actuation of the corresponding actuating portion. Since the actuating portion is arranged at the second edge side 72, the pushing member 108, in the actuated state, can also simultaneously pull the carrier plate 58 away from the other carrier plate 58, thereby distancing it therefrom. In this way, for example, coupled carrier plates 58 can be decoupled from each other.

The loading system 10 of the second embodiment comprises only one transport device 26, by means of which the containers are fed and removed. The transport device 26 comprises a handling robot 94. The handling robot 94 comprises a support structure 96 and an end effector 98 mounted thereon. The support structure 96 is configured as a multi-jointed arm. By means of the multi-jointed arm, the end effector 98 is movable in three spatial directions, i.e., horizontally and vertically. The end effector 98 comprises a gripping tool 100, by means of which one or several containers 114 can be handled, respectively. For example, the gripping tool comprises one or more grippers by means of which a respective container can be gripped. In the illustrated embodiment, the gripping tool 100 comprises two grippers, by means of each of which two containers can be handled simultaneously. In other words, the gripping tool 100 is configured to handle the containers in pairs.

The transfer plate 42 is arranged between the handling devices 32, 34, 36 and the freeze dryer. When a placement surface 54 is arranged at the level of the transfer surface 44, a distance between the placement plate 52 and the transfer plate 42 is less than half a width of a carrier plate 58. The transfer plate comprises a recess 112. The recess 112 extends in the vertical direction from the bottom side to the top side of the transfer plate 42. In this way, the linear unit 48 or the receiving device 50 can be moved vertically through the recess 112. Furthermore, the recess 112 extends from the side facing away from the freeze dryer into the transfer plate 42. The recess 112 extends in particular from the side facing away from the freeze dryer to the center of the transfer plate 42.

In the illustration of FIGS. 2 to 36, the filling module 18, the crimping module 20, the transfer stations 22 and 24, the port 51 as well as the wall of the freeze dryer 16 and partially the wall of the freeze dryer module 14 are omitted in order to better illustrate the individual processes within the loading system 10. Furthermore, only one placement plate 52 of the plurality of placement plates 52 within the freeze dryer 16 is always illustrated in FIGS. 2 to 36 in order to better illustrate the movement of the carrier plates.

In FIG. 2, an operating state is illustrated that is assumed prior to a start of a freeze-drying cycle, in particular prior to a start of filling or packaging of the containers. In this state, all carrier plates 58 are arranged in the receptacles 56 of the carrier plate holder 40. In other words, the carrier plates 58 are stored in this way in the carrier plate holder 40 until their use. In this operating state, in particular, H2O2 decontamination of the freeze-drying module can be performed. In other words, the operating state of FIG. 2 is assumed during a decontamination cycle. Thereby, each carrier plate 58 is arranged in a corresponding receptacle 56 such that the first edge side 70 is arranged at the top with respect to a vertical direction and the second edge side 72 is arranged at the bottom. Furthermore, the linear unit 48 of the second handling device 34 is arranged below the transfer plate.

Departing from the operating state of FIG. 2, the empty carrier plates are next placed into the freeze dryer 16. The placing and intermediate storing of the carrier plates 58 into the freeze dryer is thereby a special embodiment. In principle, the carrier plates 58 can also be held in the carrier plate holder 40 until they are removed from the carrier plate holder 40 and equipped with containers 114. For loading the empty carrier plates 58, the handling robot 84 transfers the carrier plates 58 one after the other to the transfer plate 42. From the transfer plate 42, the carrier plates 58 are then inserted into the freeze dryer by means of the stroke and linear unit 104.

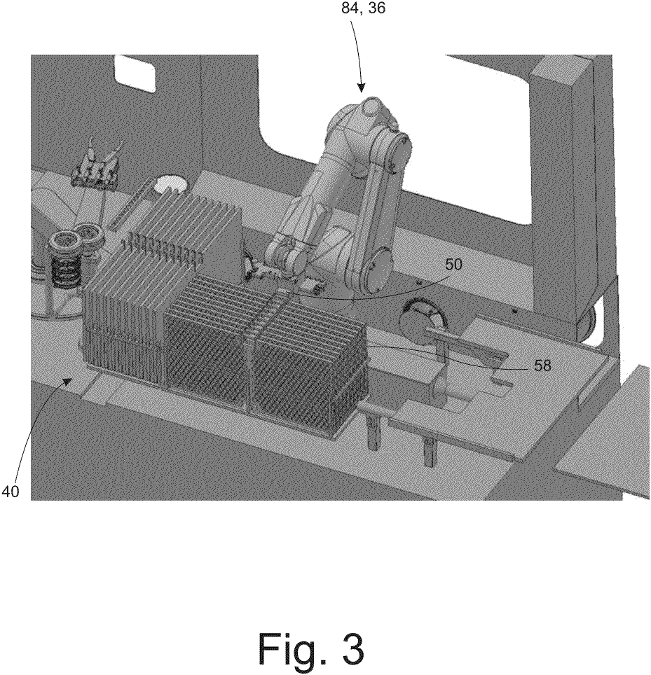

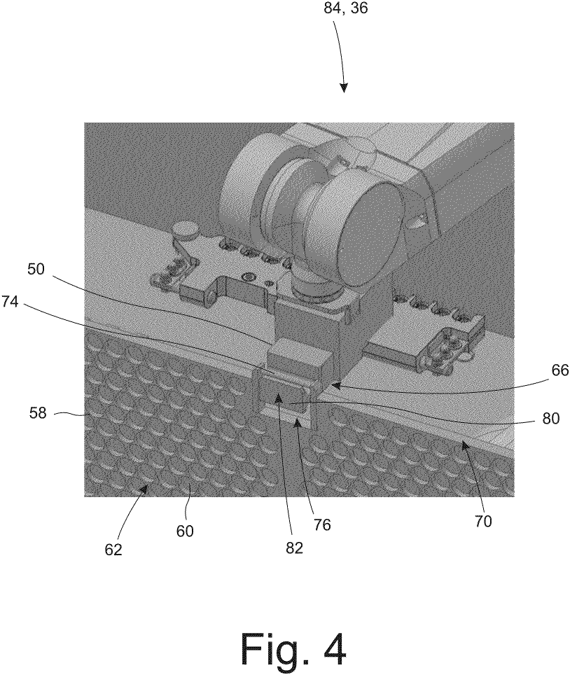

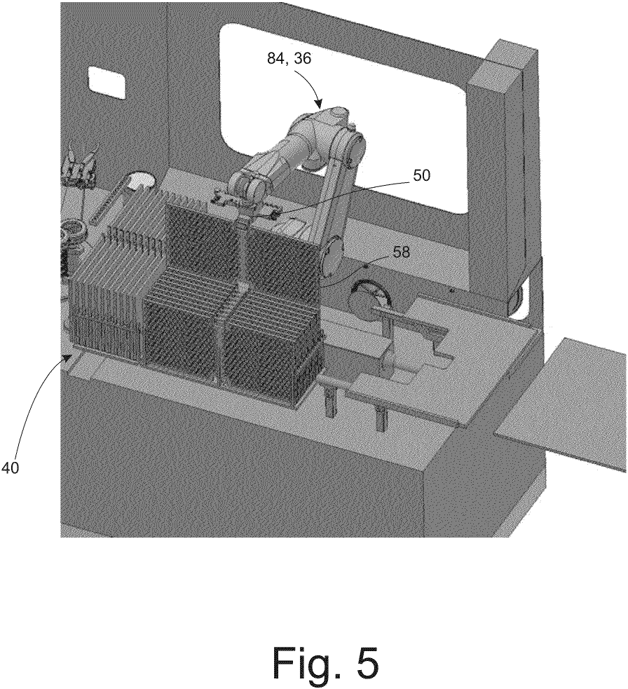

For this purpose, a placement plate 52 is arranged so that its placement surface 54 is arranged at the level of the transfer surface 44. Then, the receiving device 50 of the handling robot 84 is moved to a carrier plate 58 arranged in the carrier plate holder 40, as illustrated in FIG. 3. Since the first edge side 70 of each carrier plate 58 is arranged at the top, the first coupling portion 66 is accessible to the receiving device 50. Then, the receiving member 80 of the receiving device 50 is coupled with the holding member 74 of the carrier plate 58, as illustrated in FIG. 4. For this purpose, the receiving member 80 engages the recess 76 and the holding member 74 is received in the hook-shaped receptacle of the receiving member 80. As illustrated in FIG. 5, the receiving device 50 can be moved vertically upwardly. The carrier plate 58 coupled with the receiving device 50 is thereby also moved upwardly, in particular lifted, and lifted out of the receptacle 56. In this way, the carrier plate 58 is removed from the receptacle 56 of the carrier plate holder 40.

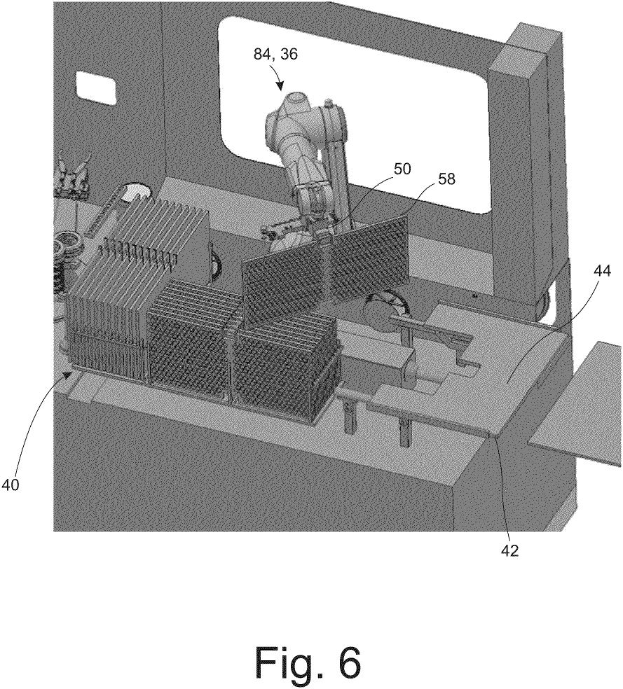

The carrier plate 58 is then transferred to the transfer plate 42, oriented, and placed on the transfer surface 44, as illustrated in FIGS. 6 to 9. For this purpose, the receiving device 50 is moved by means of the handling robot 84 correspondingly. During the transfer, the carrier plate 58 hangs at the receiving device 50. In particular, the carrier plate 58 is hung in the hook-shaped receptacle of the receiving member 80 by means of the holding member 74. Thereby, the side surfaces 62, 64 are oriented vertically. During placing of the carrier plate 58 on the transfer plate 42, the carrier plate is tilted, in particular by 90°, so that the carrier plate 58 rests with the second side surface 64 on the transfer surface 44. Thereby, the side surfaces 62, 64 are preferably oriented horizontally. The carrier plate 58 is tilted during placing such that the second edge side 72 faces the freeze dryer and the first edge side 70 faces away from the freeze dryer. With respect to the insertion direction into the freeze dryer 16, the first edge side 70 is thus arranged upstream and the second edge side 72 is arranged downstream. Thereby, the first edge side 70 of the linear unit 48 faces the second handling device 34 and the second edge side 72 faces away from the linear unit 48. The carrier plate is further placed such that the first coupling portion 66 is arranged above the recess 112. The receiving device 50 is moved downwardly through the recess 112 to decouple the receiving member 80 from the first coupling portion 66.

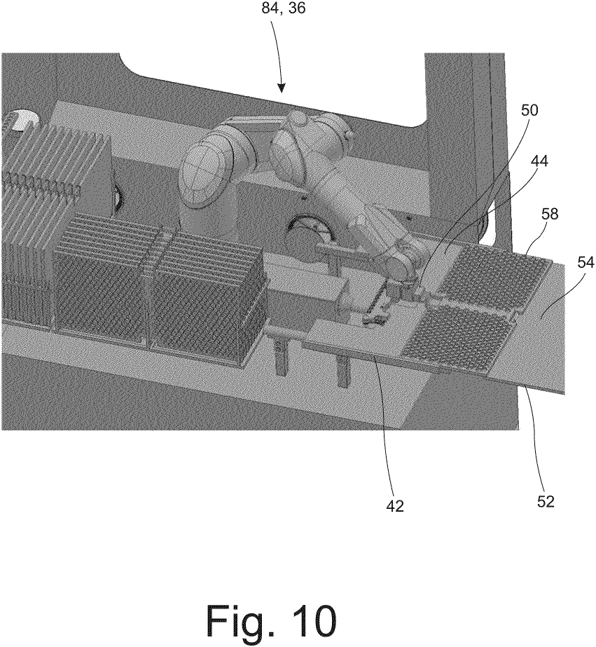

Then, the receiving device 50 is moved such that the receiving member 80 bears against the first edge side 70, in particular against the holding member 74 from the outside. By means of the receiving device 50, the carrier plate 58 is then pushed so far in the direction of the freeze dryer, in particular in the direction of the placement plate 52 arranged at the same level, until the first coupling portion 66 is at least no longer arranged above the recess 112 but above the transfer surface 44. The carrier plate 58 then projects over the edge of the transfer plate 42 in the direction of the placement plate 52. In other words, the carrier plate 58 is arranged partially above the gap between the transfer plate 42 and the placement plate 52. This is illustrated in FIG. 10. The carrier plate 58 can also be partially or fully inserted into the freeze dryer in this way by means of the receiving device 50, in particular by being displaced onto the placement plate 52.

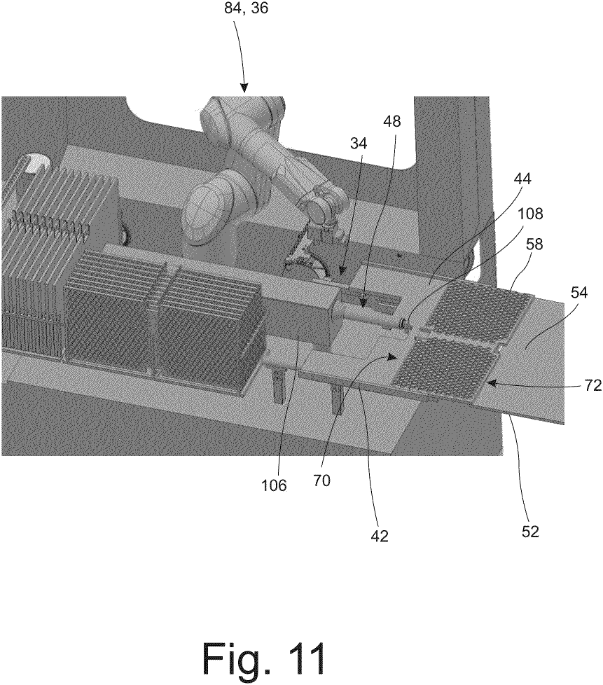

The receiving device 50 is then moved to the side and makes room for the second handling device 34. By means of the stroke unit 106, the linear unit 48 is moved through the recess 112 vertically upwardly until the linear unit 48 is arranged at the level of the carrier plate 58. This is illustrated in FIG. 11.

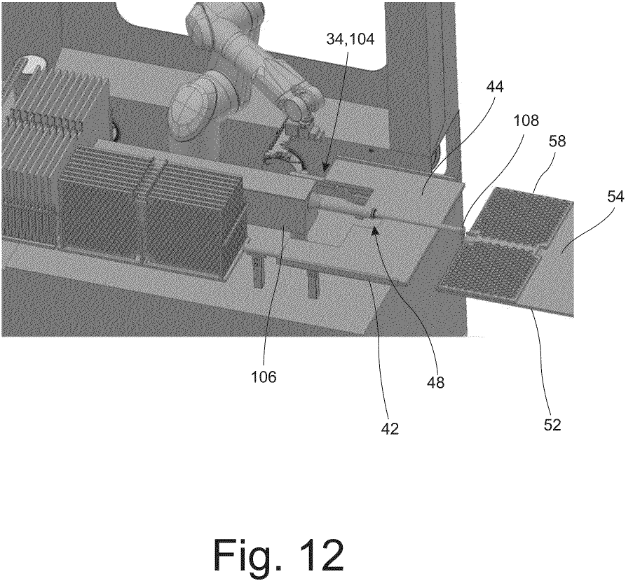

Then, the carrier plate 58 is pushed by means of the pushing member 108 of the linear unit 48 completely into the freeze dryer onto the placement surface 54, as illustrated in FIG. 12.

Subsequently, the pushing member 108 is moved back again. Then, the linear unit 48 is again moved through the recess 112 vertically downward by means of the stroke unit 106 to arrange the linear unit 48 below the transfer plate 42 again.

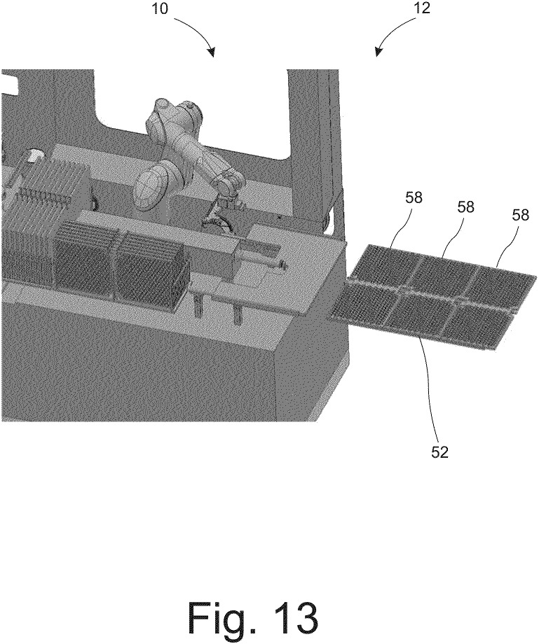

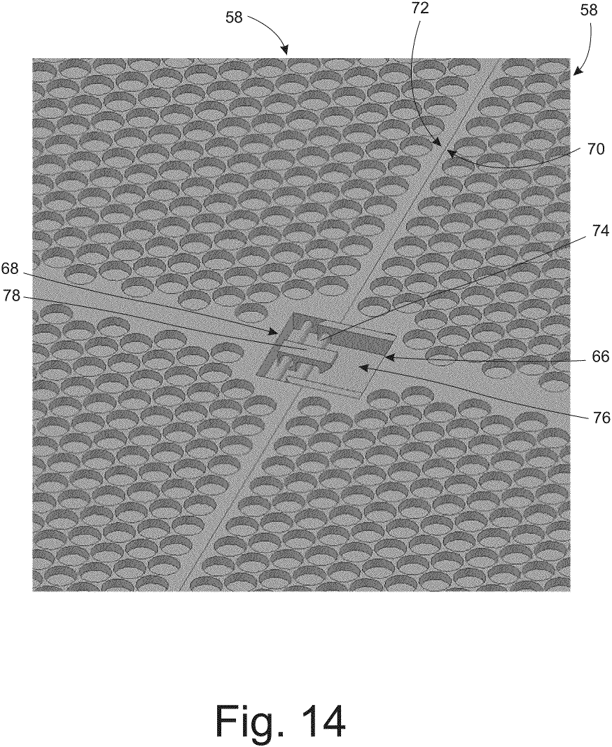

In the same way, two further carrier plates 58 are removed from the carrier plate holder 40 and pushed one behind the other onto the placement surface 54 of the placement plate 52. This is illustrated in FIG. 13. Each placement surface 54 is configured such that three carrier plates 58 can be arranged on it one behind the other. The three carrier plates 58 are thereby coupled with each other via their first and second coupling portions 66, 68. In other words, the middle carrier plate 58 is thereby coupled with the rear carrier plate 58 via its second coupling portion 68 and coupled with the front carrier plate 58 via its first coupling portion 66. The rear carrier plate 58 has been inserted first. The center carrier plate 58 has been inserted second. The front carrier plate 58 has been inserted third. During insertion of a carrier plate 58 onto the placement surface 54, the carrier plate is inserted with the second edge side 72 ahead. An inserted carrier plate 58 is oriented on the placement surface 54 such that the first edge side 70 is arranged on the side of the carrier plate 58 facing the transfer plate 42. If a first carrier plate 58 is arranged on the placement surface 54, during insertion of a second carrier plate 58, the second edge side 72 of the second carrier plate 58 is pushed onto the first edge side of the first carrier plate 58, wherein the first and second coupling portions couple together. The coupling occurs by pressing the locking member 78 of the second carrier plate 58 against the holding member 74 of the first carrier plate 58, whereby the locking member 78 couples with holding member 74 by means of the flank actuation. During the insertion of the carrier plates, each carrier plate 58 is inserted only up to a front area of the placement surface 54, respectively, since during the equally far insertion of a further carrier plate 58, the firstly inserted carrier plate 58 after the coupling is further inserted together with the further carrier plate. The coupling of two carrier plates 58 is illustrated in FIG. 14. The coupling is not strictly necessary for the joint insertion, since during the insertion, the following carrier plate 58 pushes the firstly inserted carrier plate further to the rear, as soon as the following carrier plate comes into abutment with the first carrier plate during the insertion. However, the coupling for the joint removing of the carrier plates from the freeze dryer 16 is of advantage, which will still be explained in the following.

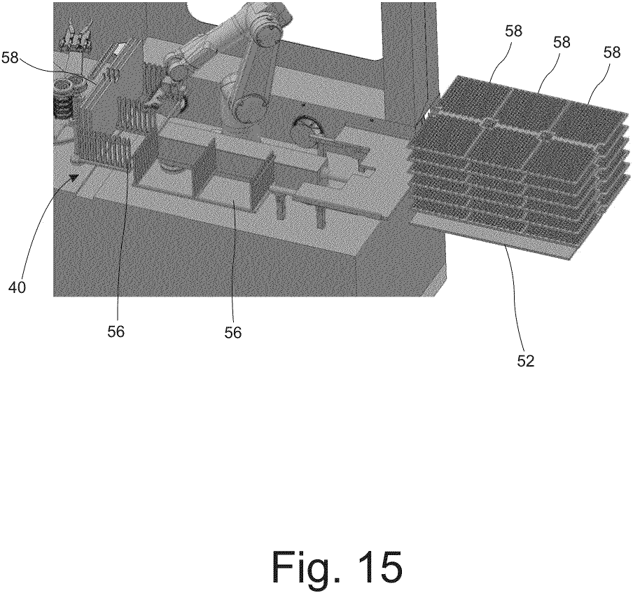

In the same way, then, also the further placement surfaces 54 of the freeze dryer are each loaded with three carrier plates from the carrier plate holder, until only one placement surface 54 remains to be loaded. This is illustrated in FIG. 15. For loading the placement surfaces 54, the placement surfaces 54 are moved one after the other to the level of the transfer surface 44 and loaded with three carrier plates each.

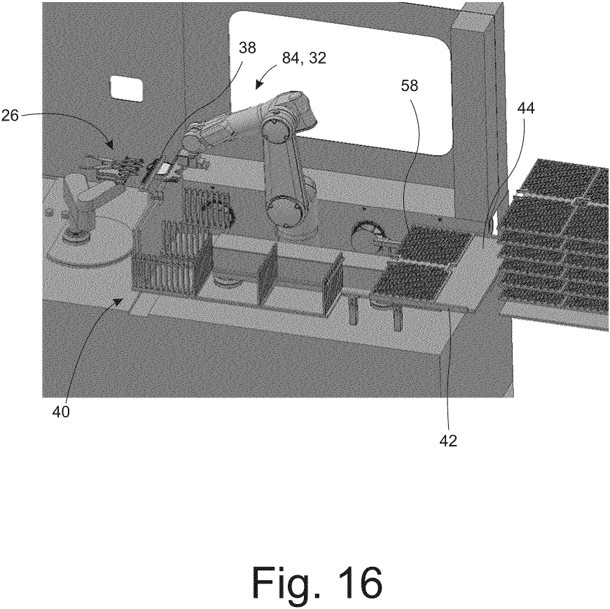

When only one placement surface 54 remains to be loaded, the receiving device 50 removes a carrier plate 58 from the carrier plate holder 40 and places it on the transfer plate 42. This is illustrated in FIG. 16.

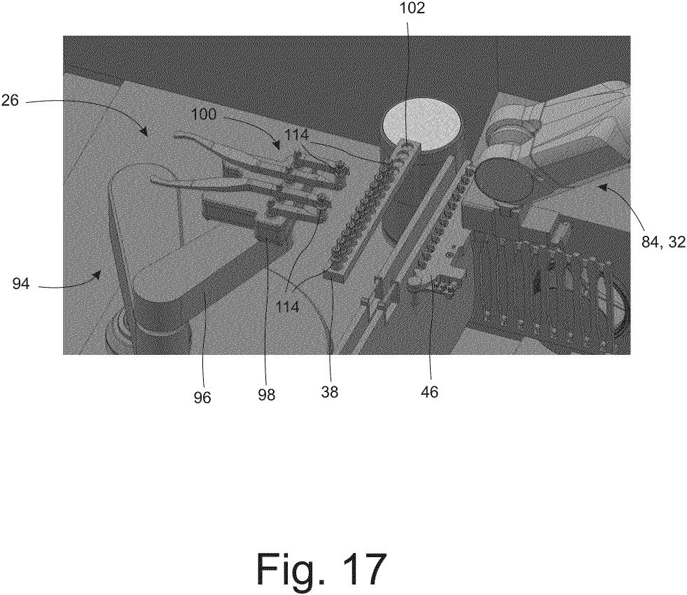

By means of the transport device 26, containers 114 are then fed to the handling station 14 and arranged in the receptacles 102 of the container holder 38. This is illustrated in FIG. 17.

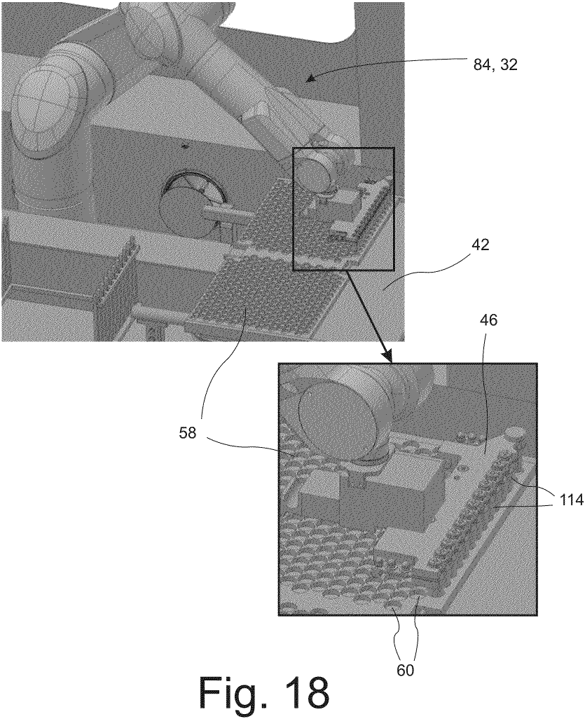

When all receptacles 102 of the container holder 38 are equipped with containers 114, the gripping device 46 is moved to the container holder 38 by means of the handling robot 84 and removes a row of containers 114. The gripping device 46 is then moved to the transfer plate 42, in particular to the carrier plate 58 arranged on the transfer plate 42, wherein the row of containers 114 is transferred thereto. The gripping device 46 then inserts the row of containers 114 into corresponding empty receptacles 60 of the carrier plate 58, which are arranged in a row. This is illustrated in FIG. 18.

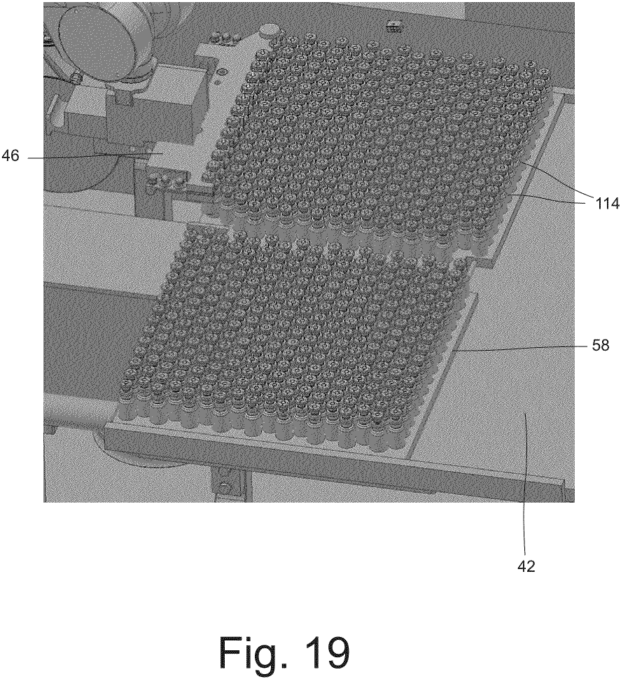

In this way, further containers 114 are fed to the container holder 38 one after the other and are inserted into the receptacles 60 of the carrier plate 58 by means of the gripping device 46 until in each receptacle 60 of the carrier plate 58 a container is inserted. This is illustrated in FIG. 19.

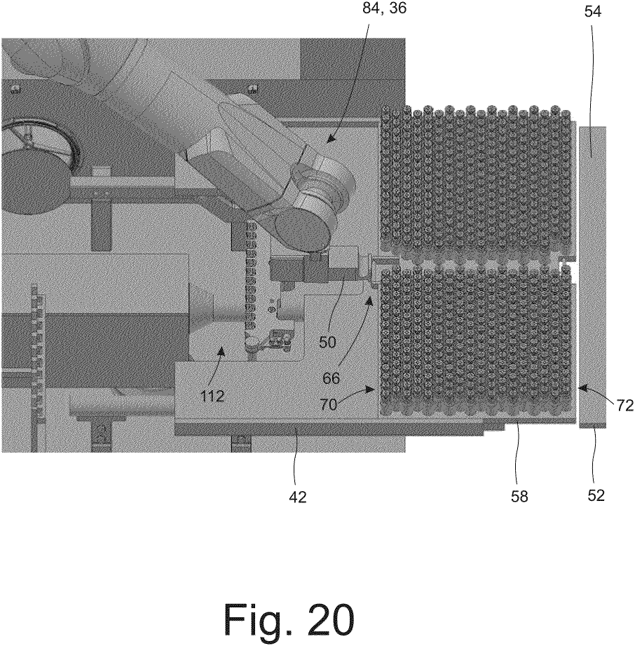

Then, the receiving device 50 is moved again such that the receiving member 80 bears against the first edge side 70, in particular against the holding member 74 from the outside. By means of the receiving device 50, the carrier plate 58 is then pushed so far in the direction of the freeze dryer, in particular in the direction of the placement plate 52 arranged at the same level, until the first coupling portion 66 is at least no longer arranged above the recess 112 but above the transfer surface 44. The carrier plate 58 then projects over the edge of the transfer plate 42 in the direction of the placement plate 52. In other words, the carrier plate 58 is partially arranged above the gap between the transfer plate 42 and the placement plate 52. This is illustrated in FIG. 20. The carrier plate 58 can also be partially or fully inserted into the freeze dryer in this way by means of the receiving device 50, in particular it can be displaced onto the placement plate 52.

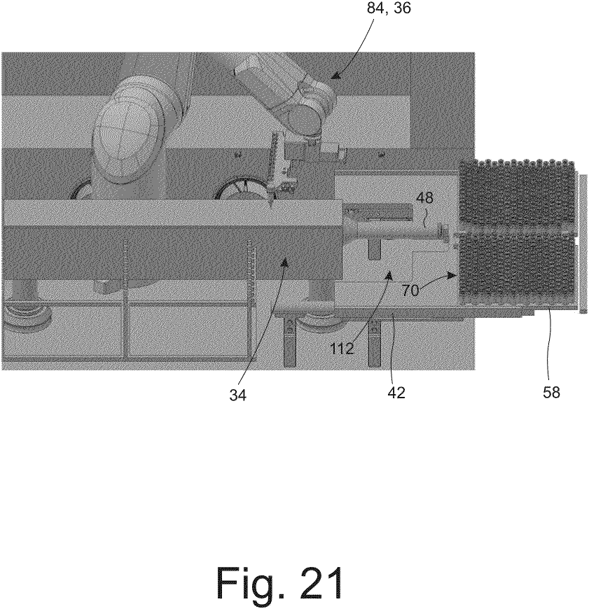

The receiving device 50 is then moved to the side and makes room for the second handling device 34. By means of the stroke unit 106, the linear unit 48 is moved through the recess 112 vertically upwardly until the linear unit 48 is arranged at the level of the carrier plate 58. This is illustrated in FIG. 21.

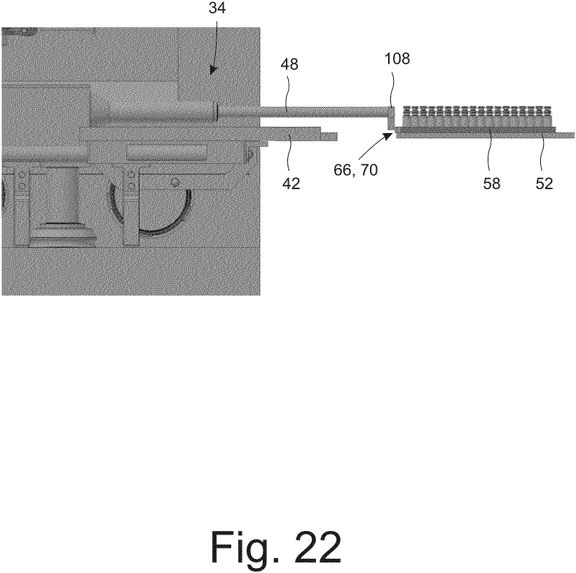

Then, the carrier plate 58 is pushed completely into the freeze dryer onto the placement surface 54 by means of the pushing member 108 of the linear unit 48. This is illustrated in FIG. 22. Subsequently, the pushing member 108 is moved back again.

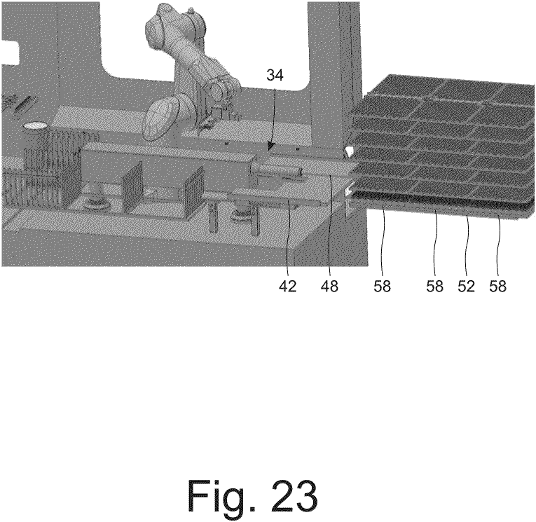

In the same way, two further carrier plates 58 are removed from the carrier plate holder 40, equipped with containers 114 and pushed one behind the other onto the placement surface 54 of the placement plate 52. This is illustrated in FIG. 23. During the insertion, the three carrier plates 58 are again coupled with each other correspondingly.

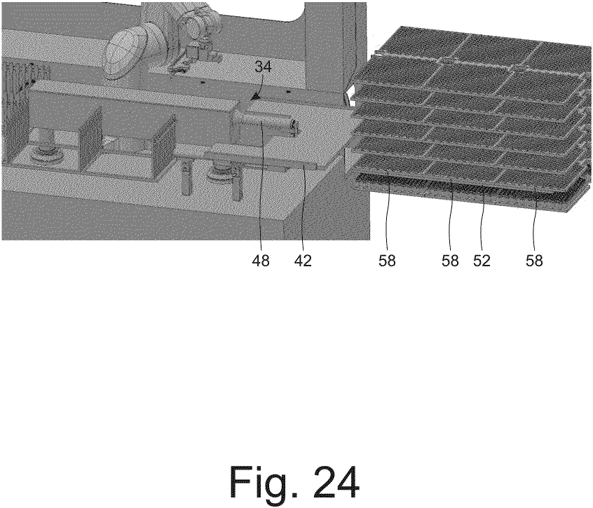

Thereafter, the placement surfaces 54 are moved vertically such that a placement surface 54 loaded with empty carrier plates 58 is arranged at the level of the transfer surface 44. This is illustrated in FIG. 24.

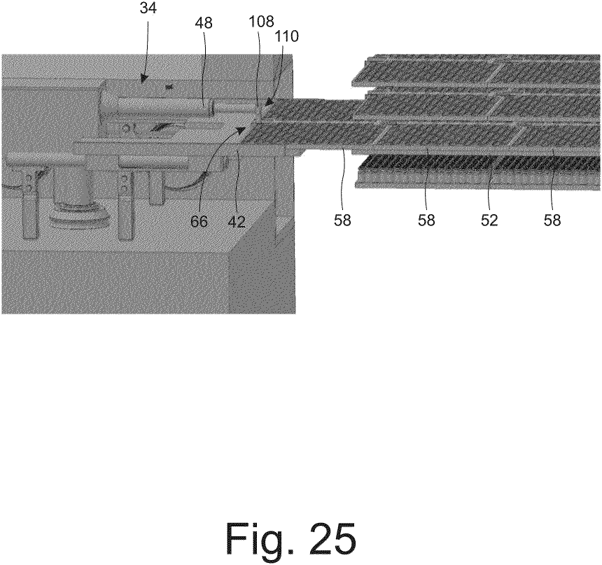

Then, the front carrier plate 58 is pulled from the placement plate 52 onto the transfer plate 42. Since the three carrier plates 58 arranged on the placement plate 52 are coupled with each other, the center carrier plate and the rear carrier plate are thereby also pulled to the front. For this purpose, the linear unit 48 and the stroke unit 106 are moved such that the protrusion of the pushing member 108 engages the recess 76 of the first coupling portion of the front carrier plate 58 so that it can be pulled. The front carrier plate 58 is pulled off the placement plate 52 so far until the center carrier plate 58 is arranged at the front edge of the placement plate 52. This is illustrated in FIG. 25.

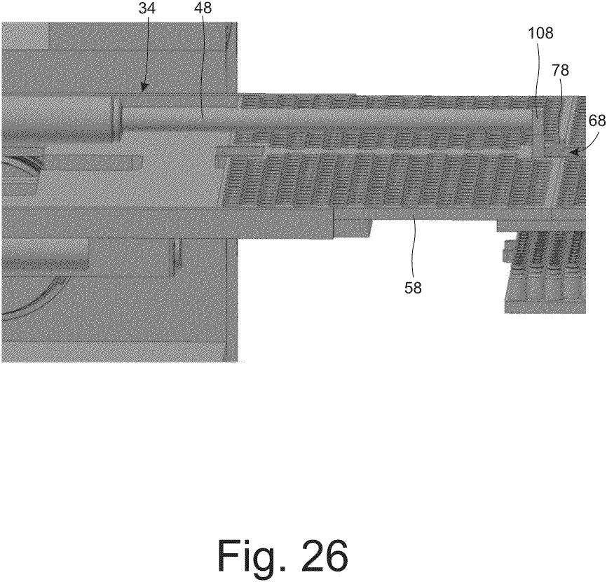

Then, the pushing member 108 is moved to the second coupling portion 68 of the front carrier plate 58, actuates the actuating portion of the locking member 78, wherein the front carrier plate 58 is decoupled from the center carrier plate 58. This is illustrated in FIG. 26.

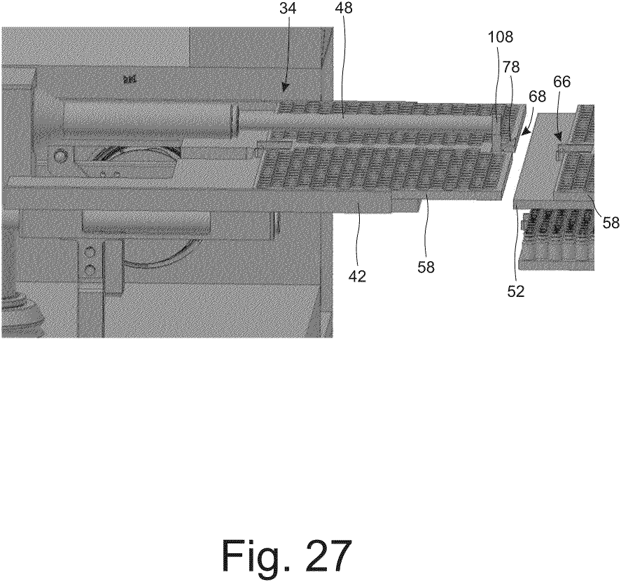

Then, the pushing member 108 pulls the front carrier plate 58, while the locking member 78 is actuated, so far onto the transfer plate 42 until the first coupling portion 66 is arranged over the recess 112. This is illustrated in FIG. 27. Thereafter, the pushing member 108 is again removed from the recess 76 and moved back. Then, the linear unit 48 is moved by means of the stroke unit 106 vertically downward through the recess 112 to arrange the linear unit 48 below the transfer plate 42 again.

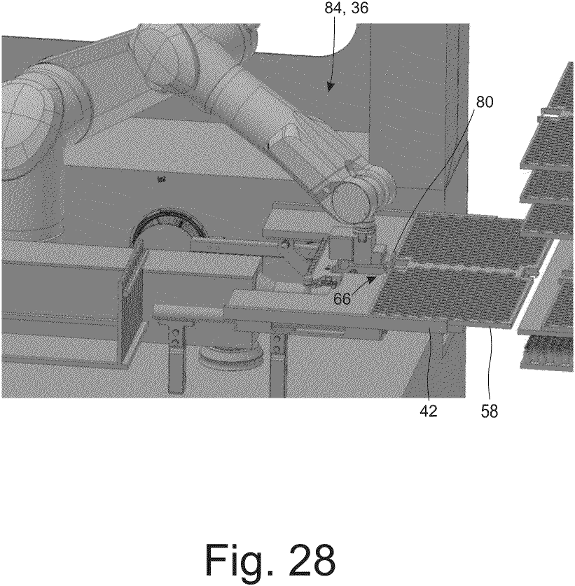

Then, the receiving device 50 is moved to the first coupling portion of the front carrier plate 58 and coupled therewith. For this purpose, the receiving member 80 is moved from below through or in the recess 112 upwardly, such that the holding member 74 is received in the hook-shaped receptacle of the receiving member 80. This is illustrated in FIG. 28.

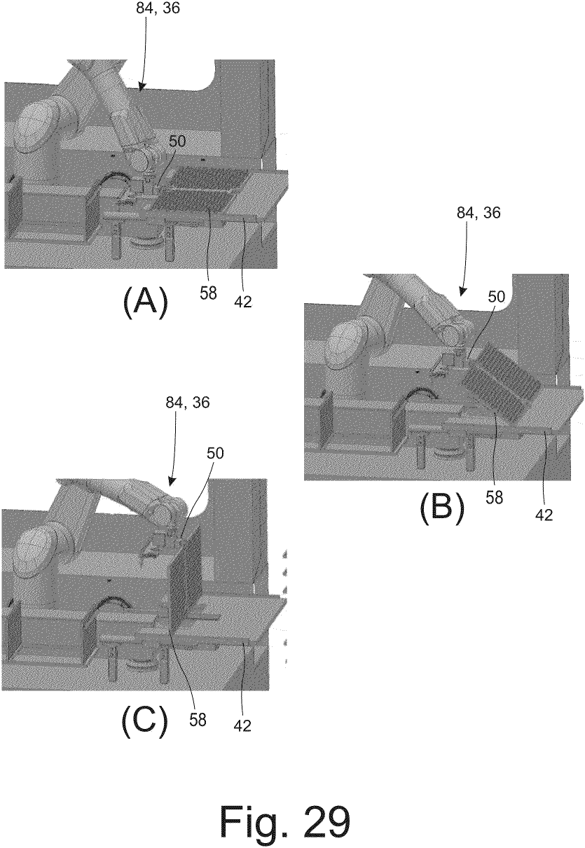

Then, the carrier plate 58 is lifted by means of the receiving device 50. This is illustrated in FIGS. 29 (A) to (C) . During lifting, the carrier plate is pivoted such that the side surfaces are transferred from a horizontal orientation to a vertical orientation.

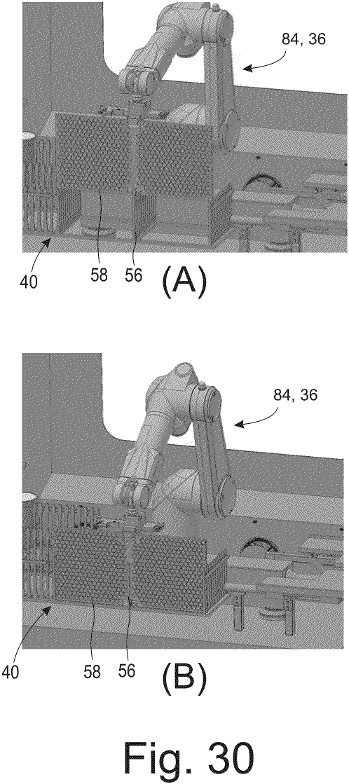

The carrier plate is then transferred to a receptacle 56 of the carrier plate holder 40 by means of the receiving device 50 and inserted therein. This is illustrated in FIGS. 30 (A) and (B). After the insertion, the receiving member is again decoupled from the first coupling portion.

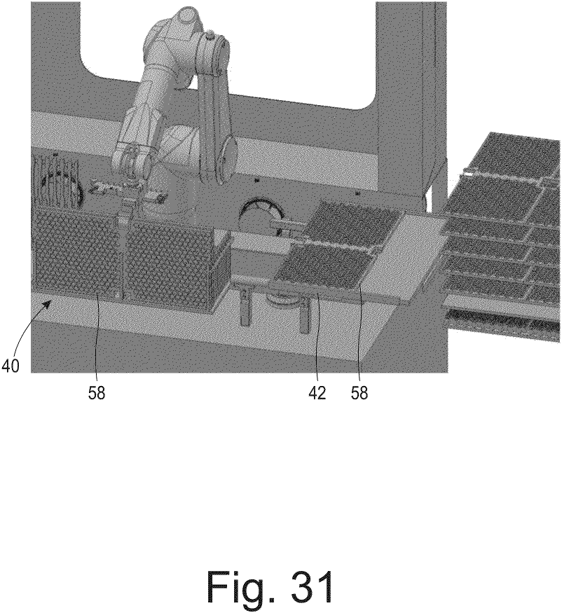

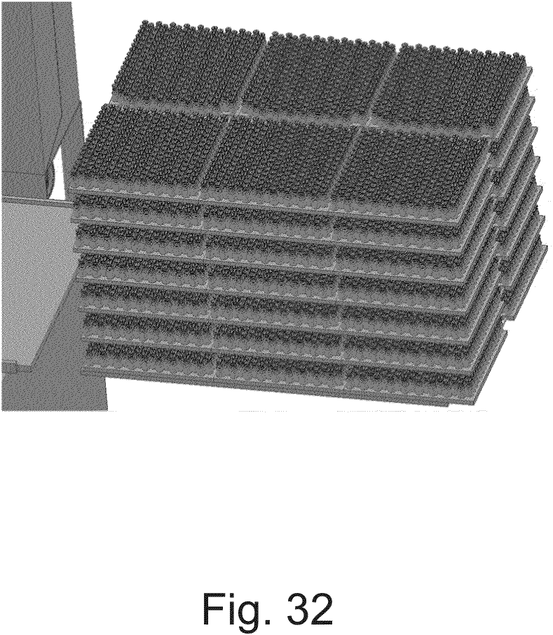

In the same way, the center carrier plate 58 is pulled out from the placement surface 54 onto the transfer plate 42, and from there is further transferred into the carrier plate holder 40. Then, the rear carrier plate is pulled out from the placement surface onto the transfer plate by means of the linear unit so far until the first coupling portion is arranged above the transfer surface 44 or above the recess. Then, the linear unit is again arranged below the transfer plate 42 and the receiving device 50 can pull the carrier plate 58 further to the front. This is illustrated in FIG. 31.

Then, the three carrier plates 58 are again equipped with containers 114 corresponding to the description of FIGS. 16 to 23 and pushed onto the placement surface 54 of the freeze dryer.

In this way, all placement surfaces 54 of the freeze dryer are loaded one after the other with equipped carrier plates 58. In FIG. 32, the state is illustrated in which all placement surfaces 54 are loaded with equipped carrier plates 58. In other words, the freeze dryer is thereby completely loaded.

After the freeze-drying, the carrier plates 58 are removed from the freeze dryer again and the containers 114 are removed from the receptacles 60 of the carrier plates 58 and removed.

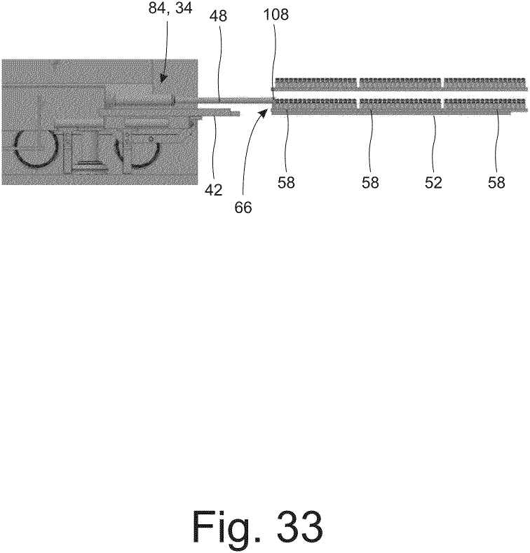

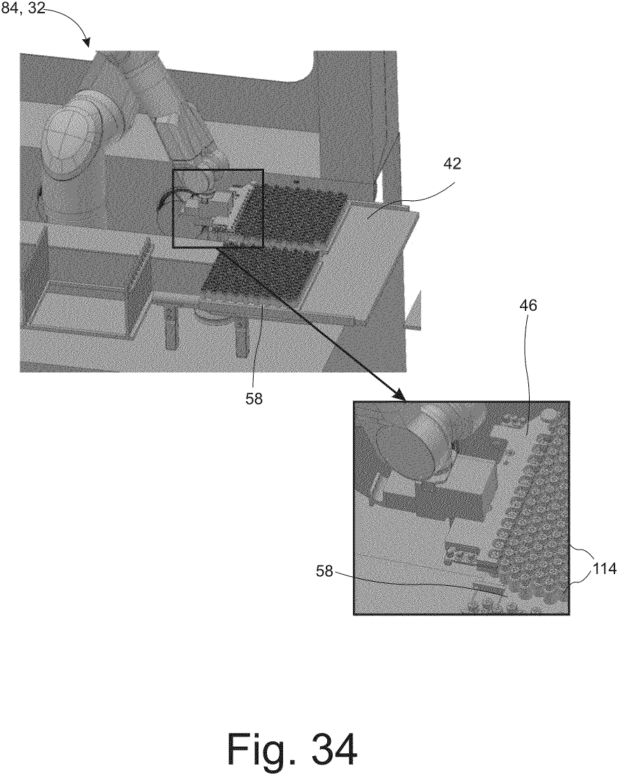

For this purpose, the carrier plates 58 are pulled from each placement surface 54 by means of the linear unit 48 one after the other onto the transfer plate 42. There, the containers 114 are then removed from the receptacles 60 by means of the gripping device 46, transferred to the container holder 38, and inserted into the receptacles 102 of the container holder 38. Thereby, the containers are again handled in rows. This is illustrated in FIGS. 33 and 34.

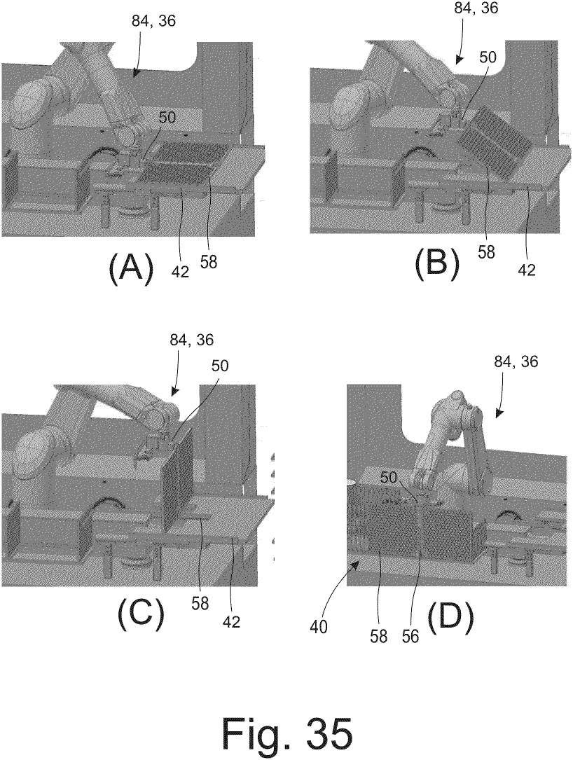

After the removing of the containers 114, each empty carrier plate 58 is inserted into an empty receptacle of the carrier plate holder 40. This is illustrated in FIGS. 35 (A) through (D). Thereby, the carrier plate is handled corresponding to the description of FIGS. 29 and 30.

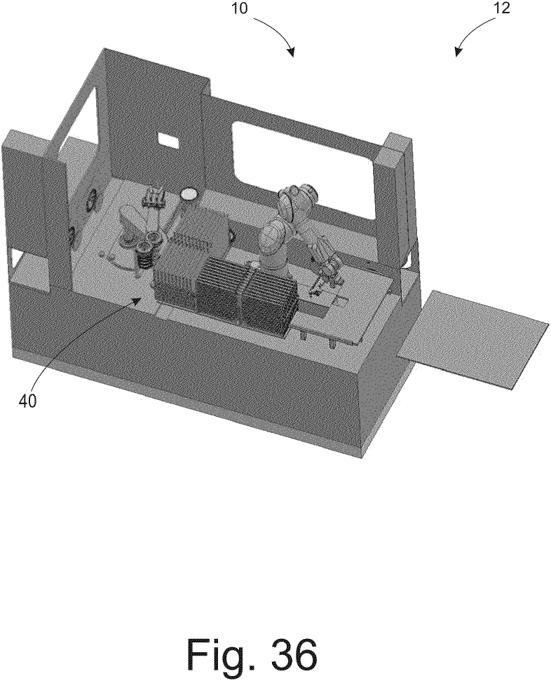

In this way, all carrier plates 58 are removed one after the other from the freeze dryer 16, the containers 114 are removed from the receptacles 60, and the carrier plates 58 are subsequently stored again in the carrier plate holder 40. This state is illustrated in FIG. 36. When the freeze dryer 16 is completely emptied and all carrier plates 58 are again arranged in the carrier plate holder 40, an automatic washing cycle can be performed by cleaning the carrier plates 58, in particular by means of a sprinkler system. The washing cycle can be performed in the complete interior of the isolator. After a filling cycle or batch, the interior is decontaminated with H₂O₂, if required, and cleaned manually or automatically (wash cycle).

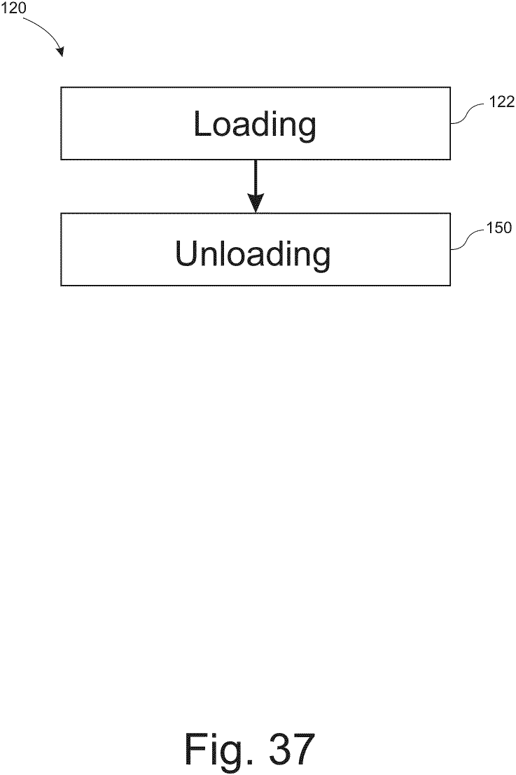

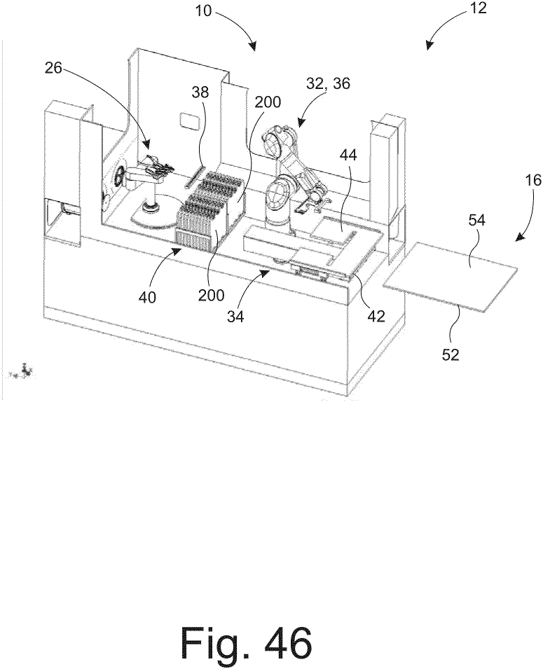

FIG. 37 shows an embodiment of a method 120 for handling containers filled with a medical, pharmaceutical, or cosmetic substance, in the loading system 10 for a freeze dryer. In particular, the containers 114 can be handled in the loading system 10 according to FIG. 1, or the loading system 10 according to FIGS. 2 to 36, or the loading system 10 according to FIGS. 46 to 63, corresponding to the method 120.

The handling of the containers 114 in the loading system 10 can comprise, on the one hand, the loading 122 of the freeze dryer 16. Thereby, the containers 114 are inserted into the freeze dryer 16 by means of the carrier plates 58.

The handling of the containers 114 in the loading system 10 can alternatively or additionally comprise the unloading 150 of the freeze dryer 16. Thereby, the containers 114 arranged in the carrier plates 58 are removed from the freeze dryer 16.

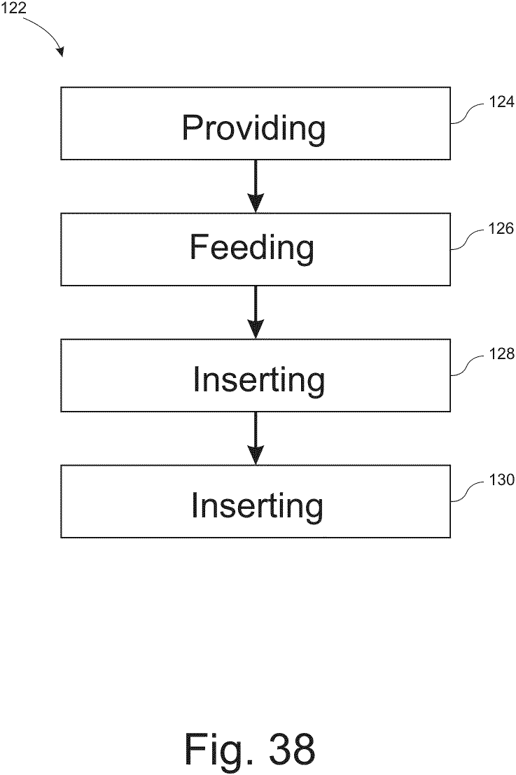

FIG. 38 shows the loading 122 of the freeze dryer 16 of FIG. 37.

In a first step 124 of the loading 122, an empty carrier plate 58 is provided in a handling station 30, wherein the carrier plate 58 comprises a plurality of receptacles 60 each configured to receive one of the containers 114.

In a further step 126 of the loading 122, containers 114 are fed to the handling station 30.

In a further step 128 of the loading 122, the containers 114 are received in the receptacles 60 of the carrier plate 58 by means of the first handling device 32.

In a further step 130 of the loading 122, the carrier plate 58 is inserted into the freeze dryer 16 by means of the second handling device 34. Preferably, the carrier plate 58 is thereby inserted from the handling device 30 into the freeze dryer 16 by means of the second handling device 34, in particular wherein the carrier plate 58 is pushed from a transfer plate 42 of the handling device 30 onto a placement surface 54 of the freeze dryer 16.

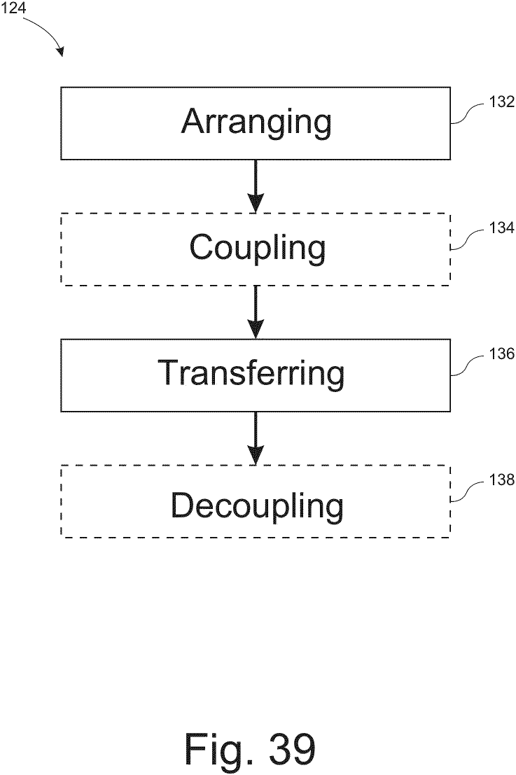

In FIG. 39, steps are shown that can be performed for providing 124 the carrier plate 58.

In a first step 132 of the providing 124 of the carrier plate 58, a plurality of carrier plates 58 are arranged in a carrier plate holder 40 of the handling station 30.

In a further optional step 134 of the providing 124 of the carrier plate 58, the third handling device 36 is coupled with one of the carrier plate 58 arranged in the carrier plate holder 40 that shall be provided.

In a further step 136 of the providing 124 of the carrier plate 58, the carrier plate 58 is transferred from the carrier plate holder 40 to the transfer plate 42 by means of the third handling device 36.

In a further optional step 138 of the providing 124 of the carrier plate 58, the third handling device 36 is decoupled from the transferred carrier plate 58.

As an alternative to the steps illustrated in FIG. 39, for providing 124 the carrier plate 58, the carrier plate 58 can also be previously arranged in the freeze dryer 16, in particular on one of the placement surfaces 54 of the freeze dryer 16, and removed from the freeze dryer 16 by means of the second handling device 34, in particular wherein the carrier plate 58 is pulled from the placement surface 54 onto the transfer plate 42.

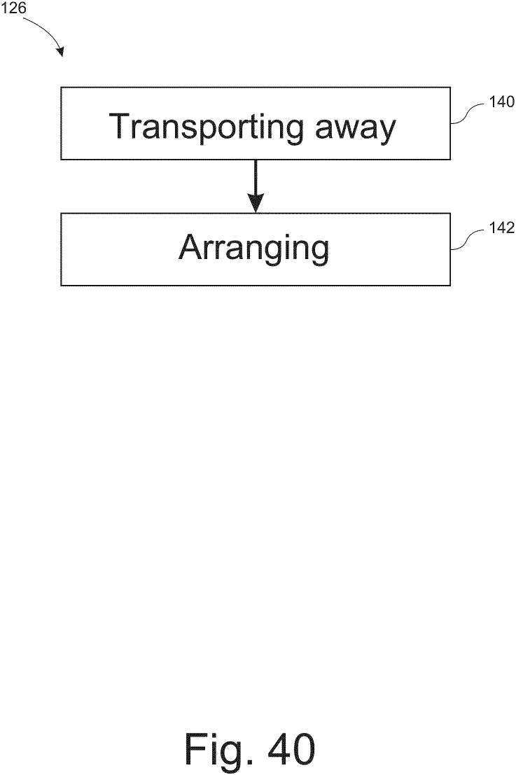

In FIG. 40, steps are shown that can be performed for feeding 126 the containers 114.

In a first step 140 of the feeding 126 of the containers 114, the containers 114 are transported to the container holder 38 of the handling station 30 by means of the transport device 26.

In a further step 142 of the feeding 126 of the containers 114, the fed containers 114 are arranged in the container holder 38. For arranging 142 the containers 114, the containers 114 are inserted into the receptacles 102 of the container holder 38. Thereby, the fed containers 114 can be collected in the container holder 38.

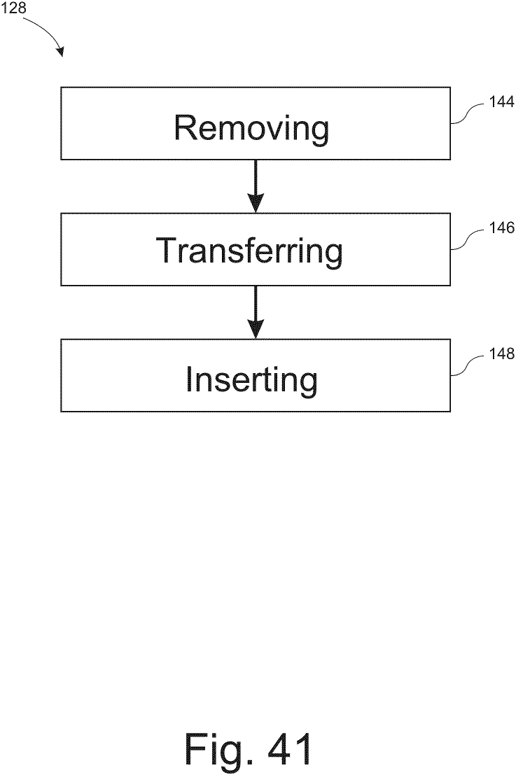

In FIG. 41, steps are shown that can be performed for inserting 128 the containers 114.

In a first step 144 of the inserting 128 of the containers 114, one or several containers 114, in particular a row of containers 114, are each removed from the container holder 38 by means of the first handling device 32.

In a further step 146 of the inserting 128 of the containers 114, the removed containers 114 are transferred by means of the first handling device 32 to the carrier plate 58 which is arranged on the transfer plate 42.

In a further step 148 of the inserting 128 of the containers 114, the transferred containers 114 are inserted into empty receptacles 60 of the carrier plate 58 by means of the first handling device 32.

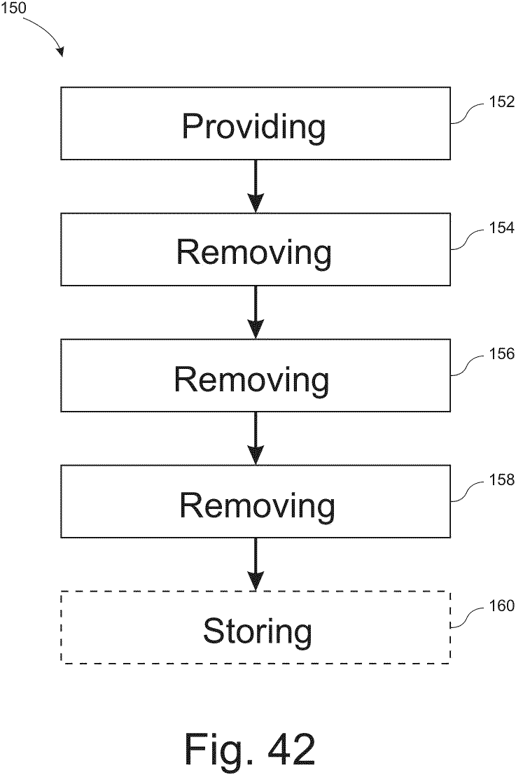

FIG. 42 shows the unloading 150 of the freeze dryer 16 of FIG. 37.

In a first step 152 of the unloading 150, a carrier plate 58 equipped with containers 114 is provided in the freeze dryer 16. The providing can be performed in the method 120 of FIG. 37 by the loading 122 of the freeze dryer 16.

In a further step 154 of the unloading 150, the carrier plate 58 is removed from the freeze dryer 16 by means of the second handling device 34.

In a further step 156 of the unloading 150, the containers 114 are removed in the handling station 30 from the receptacles 60 of the carrier plate 58 by means of the first handling device 32.

In a further step 158 of the unloading 150, the containers 114 are removed from the handling station by means of the transport device 26 or the transport device 28. Preferably, the carrier plate 58 is pulled out of the freeze dryer 16 by means of the second handling device 34, in particular wherein the carrier plate 58 is pulled from the placement surface 54 onto the transfer plate 42 of the handling station 30.

In a further optional step 160 of the unloading 150, the carrier plates are stored in the carrier plate holder 40.

Alternatively, the carrier plates 58 can also be stored in the freeze dryer 16. For this purpose, the emptied carrier plate 58 can be inserted into the freeze dryer 16 by means of the second handling device 34, in particular wherein the emptied carrier plate 58 is pushed from the transfer plate 42 onto the placement surface 54 of the freeze dryer 16 by means of the second handling device 34.

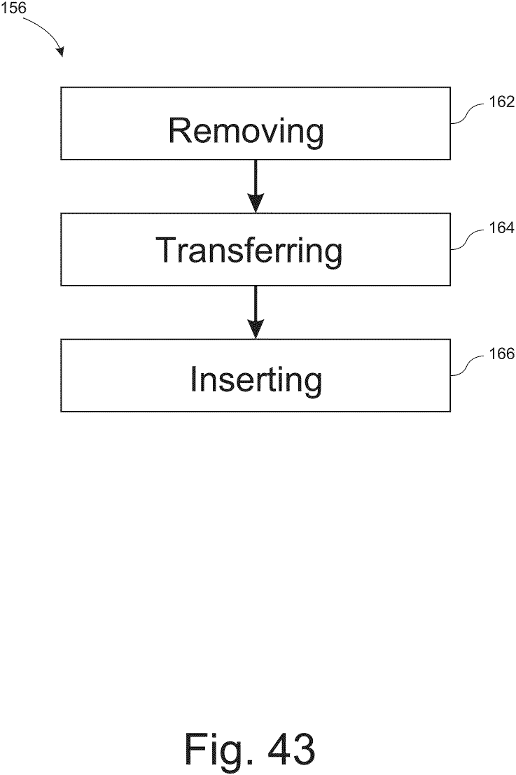

In FIG. 43, steps are shown that can be performed for removing 156 the containers 114.

In a first step 162 of the removing 156 of the containers 114, one or several containers 114, in particular a row of containers 114, are each removed from the receptacles 60 of the carrier plate 58 by means of the first handling device 32.

In a further step 164 of the removing 156 of the containers 114, the removed containers 114 are transferred to the container holder 38 by means of the first handling device 32.

In a further step 166 of the removing 156 of the containers 114, the transferred containers 114 are inserted into the container holder 38 by means of the first handling device 32. Thereby, the containers 114 are inserted into the receptacles 102 of the container holder 38. In the container holder 38, the containers 114 to be transported away can be collected.

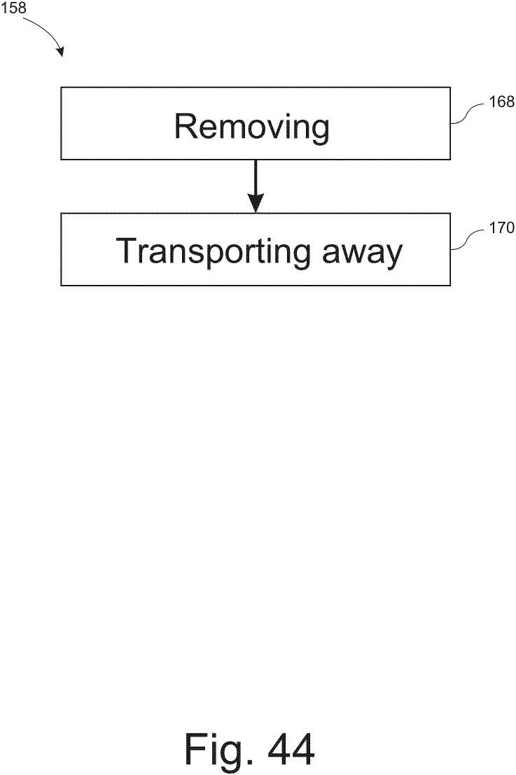

In FIG. 44, steps are shown that can be performed for removing 158 the containers 114.

In a first step 168 of the removing 158 of the containers 114, the containers are removed from the container holder 38, in particular from the receptacles 102 of the container holder 38, by means of the transport device 26 or the transport device 28.

In a further step 170 of the removing 158 of the containers 114, the containers 114 are transported away by means of the transport device 26 or the transport device 28.

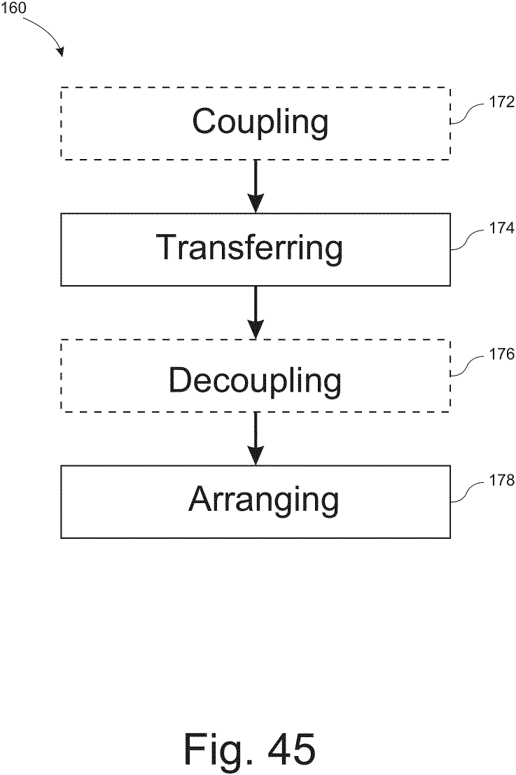

In FIG. 45, steps are shown that can be performed for storing 160 the containers 114.

In a first optional step 172 of the storing 160 of the containers 114, the third handling device 36 is coupled with the carrier plate 58 arranged on the transfer plate 42.

In a further step 174 of the storing 160 of the containers 114, the carrier plate 58 is transferred by means of the third handling device 36 from the transfer plate 42 to the carrier plate holder 40.

In a further step 176 of the storing 160 of the containers 114, the third handling device 36 is decoupled from the transferred carrier plate 58.

In a further optional step 178 of the storing 160 of the containers 114, the transferred carrier plate 58 is arranged in the carrier plate holder 40, in particular in an empty receptacle 56 of the carrier plate holder 40.

FIGS. 46 to 63 show a third embodiment of the loading system 10. The loading system 10 is illustrated in various operating positions in FIGS. 46 to 63. The loading system 10 of the third embodiment corresponds substantially to the loading systems 10 of the first and second embodiments of FIGS. 1 to 36. The same elements are identified by the same reference signs and are not explained in further detail.

The loading system 10 of the third embodiment differs in particular from the loading system 10 of the second embodiment in that the carrier plates, the carrier plate holder 40, the linear unit 48 of the second handling device 34, the receiving device 50 of the third handling device 36, and the transfer plate 42 are configured differently.

The carrier plates of the third embodiment are identified by the reference sign 200. The carrier plates 200 of the third embodiment correspond substantially to the carrier plates 58 of the second embodiment. The carrier plates 200 differ from the carrier plates 58 of the second embodiment in the shape of the base surface and in the arrangement and configuration of the coupling portions.

The carrier plates 200 substantially have a square base surface. In other words, the side surfaces 62, 64 each have a square shape. The rows of receptacles 60 are arranged in the width direction on the first side surface 62 one after the other. Each row extends in the length direction of the carrier plate 200.

The receptacles 56 of the carrier plate holder 40 of the third embodiment of the loading system 10 compared to the receptacles 56 of the second embodiment of the loading system 10 are adapted to the changed square shape of the carrier plates. In particular, instead of one wide receptacle 56, two narrow receptacles 56 are arranged next to each other, respectively.

The carrier plates 200 comprise substantially the same width as the carrier plates 58. Due to the square shape, however, the carrier plates 200 are only half as long as the carrier plates 58. As a result, in the carrier plate holder 40 two carrier plates 200 each can be arranged next to each other. Furthermore, also on the transfer surface 44 and on the placement surface 54, two carrier plates 200 can be arranged next to each other perpendicular to the insertion direction due to the halved space requirement.

Furthermore, the carrier plates 200 of the third embodiment of the loading system 10 as compared to the carrier plates 58 of the second embodiment of the loading system 10 are arranged oppositely in the receptacles 56, on the transfer surface 44 and on the placement surface 54, respectively. This means that the carrier plates 200 are oriented such that the first and second edge sides 70, 72 are reversed in contrast to the arrangement in FIGS. 2 through 36. The carrier plates 200 are arranged in the receptacles 56 such that the second edge side 72 is oriented upwardly and the first edge side 70 is oriented downwardly. On the transfer surface 44, the carrier plates 200 are arranged such that the second edge side 72 is arranged on the side facing away from the freeze dryer 16 and the first edge side 70 is arranged on the side facing the freeze dryer 16. On the placement surface 54, the carrier plates 200 are arranged such that the second edge side 72 is arranged on the side facing the transfer plate 42 and the first edge side 70 is arranged on the side facing away from the transfer plate 42. With respect to the insertion direction into the freeze dryer 16, the first edge side 70 is thus arranged downstream and the second edge side 72 is arranged upstream.

The carrier plates 200 of the loading system 10 of the third embodiment are couplable with each other by means of the first and second coupling portions 66, 68. In particular, the coupling portions 66, 68 in the loading system 10 of the third embodiment are configured substantially the same as the coupling portions 66, 68 in the loading system 10 of the second embodiment. The coupling portions 66, 68 in the loading system 10 of the third embodiment differ from the coupling portions 66, 68 in the loading system 10 of the second embodiment in that the locking member 78 is biased into the uncoupling state by means of spring force of a spring member, for example a spiral spring, or by means of gravity. The biasing by means of gravity is achieved, for example, in that the center of gravity of the locking member 78 lies with respect to the rotational axis on the side opposite to the hook portion.

Furthermore, the locking member 78 is configured so as to be arranged in the coupling state when the second coupling portion 68 is arranged on a surface, in particular the placement surface 54. In particular, the locking member 78 is configured such that it is displaced from the uncoupling state to the coupling state when the second coupling portion 68 is pushed onto a surface, in particular the placement surface 54. Correspondingly, the locking member 78 is also configured such that it is displaced from the coupling state to the uncoupling state when the second coupling portion 68 is pulled off a surface, in particular the placement surface 54. For this purpose, the locking member 78 can comprise, for example, on the side which is arranged opposite to the hook portion with respect to the rotational axis, a flank which is arranged on the bottom side of the locking member 78. During the pushing of the carrier plate 200 onto a surface, this flank comes into contact with the edge of the surface once the second coupling portion 68 has reached the edge. When the carrier plate is pushed further, the locking member 78 is displaced from the uncoupling state to the coupling state by the force exerted via the flank in a direction of rotation opposite to the biasing force. Correspondingly, the locking member 78 is again displaced from the coupling state to the uncoupling state by the biasing force as soon as the locking member 78 is no longer in contact with the surface when the carrier plate 200 is pulled off the surface.

The carrier plates 200 comprise two third coupling portions 202, 204 in addition to the first and second coupling portions 66, 68. The third coupling portions 202, 204 are arranged on the second edge side 72. The third coupling portions 202, 204 are arranged in the length direction on both sides of the second coupling portion 68. The third coupling portions 202, 204 comprise the same distance with respect to the longitudinal direction to the second coupling portion 68, in particular to a center of the second edge side 72. In other words, the third coupling portions 202, 204 are arranged symmetrically to the second coupling portion 68, in particular to a center of the second edge side 72. The third coupling portions 202, 204 are configured the same as the first coupling portion 66. For this purpose, each third coupling portion 202, 204 comprises a holding member 214 and a recess 216. The holding member 214 is configured as a web, in particular as a bar, which extends in the length direction of the carrier plate 200 from one side of the recess 216 to an opposite side of the recess 216. The web is preferably arranged parallel to the first and the second side surfaces 62, 64 and parallel to the first and the second edge sides 70, 72. The web is preferably arranged at an outer end of the recess 216.

The third coupling portions 202, 204 and the receiving device 50 are configured such that they are couplable with each other. For this purpose, the receiving device 50 comprises two receiving members 206, 208. The receiving members 206, 208 have the same distance from each other as the two third coupling portions 202, 204. The receiving members 206, 208 can each couple with a corresponding third coupling portion 202, 204 to move the carrier plate 200.

Each receiving member 206, 208 comprises an upper coupling portion 210 and a lower coupling portion 212. The upper coupling portion 210 is arranged on a top side of the corresponding receiving member 206, 208 in the operating state. The lower coupling portion 212 is arranged on a bottom side of the corresponding receiving member 206, 208 in the operating state. The upper and lower coupling portions 210, 212 are each configured hook-shaped. In other words, each receiving member 206, 208 comprises a hook-shaped receptacle in the area of each coupling portion 210, 212. In the operating state, the hook-shaped receptacle of each upper coupling portion 210 is upwardly open and the hook-shaped receptacle of each lower coupling portion 212 is downwardly open.

For coupling with the third coupling portions 202, 204 of a carrier plate 200, the hook-shaped receptacles of the upper coupling portions 210 can each receive a holding member 214 of the third coupling portions 202, 204 of the carrier plate 58. By means of this coupling, the carrier plate 200 can be moved vertically, in particular lifted and lowered, as well as moved or transferred horizontally. When the carrier plate 200 is fully lifted, the side surfaces 62, 64 of the carrier plate 200 are vertically oriented and the first and second edge sides 70, 72 are correspondingly horizontally oriented, wherein the second edge side 72 is oriented at the top and the first edge side 70 is oriented at the bottom.

For coupling with the third coupling portions 202, 204 of a carrier plate 200, furthermore, the hook-shaped receptacles of the lower coupling portions 212 can also each receive a holding member 214 of the third coupling portions 202, 204 of the carrier plate 58. By means of this coupling, the carrier plate 200 can be moved horizontally, in particular pulled and pushed, when the carrier plate 200 rests on a surface, in particular on the transfer surface 44 or on one of the placement surfaces 54, in the operating state.

The linear unit 48 can move, in particular push and pull, at least two carrier plates 200 horizontally at the same time. As previously described, two carrier plates 200 can be arranged next to each other on the transfer plate 42 and on the placement plate 52 perpendicular to the insertion direction. The linear unit 48 can push two carrier plates 200 arranged next to each other in the insertion direction from the transfer plate 42 onto one of the placement plates 52, and correspondingly pull them back from the placement plate 52 onto the transfer plate 42 against the insertion direction. For this purpose, the linear unit 48 comprises a pushing member 218. The linear unit 48 is configured to move the pushing member 218 back and forth in a, preferably horizontal, direction. The pushing member 218 comprises a rod that extends in the insertion direction, and pushing part that extends perpendicular to the insertion direction. One end of the rod is arranged centrally at the pushing part. As a result, the pushing member is configured T-shaped. The pushing member 218 is coupled with a base body of the linear unit 48, wherein the pushing member 218 is movable relative to the base body. Thereby, the pushing member 218 can be extended in the direction of the freeze dryer 16, that is, in the insertion direction, or retracted in the opposite direction. Thereby, the pushing member 218 is displaceable between a retracted state and an extended state. In other words, the pushing member 218 can push and pull the carrier plates 200 by means of this movement.

The pushing member 218 comprises four coupling portions 220. Each coupling portion 220 is arranged on the bottom side of the pushing member 218. Each coupling portion 220 is configured, for example, as a protrusion that extends downward from the bottom side of the pushing member 218. The coupling portions 220 are couplable with third coupling portions of the carrier plates 200. For coupling with a third coupling portion, the protrusion of a coupling portion 220 engages the recess 216 of the respective third coupling portion 202, 204. In other words, for coupling, the protrusion is brought into engagement with the recess 216, and for decoupling, the protrusion is brought out of engagement again. The coupling portions 220 comprise the same distance from each other as the third coupling portions 202, 204 of two carrier plates 200 arranged next to each other perpendicular to the insertion direction.

For moving two carrier plates 200 arranged next to each other, the pushing member 218 can be moved to the second edge side 72 of the two carrier plates 200. Then, the pushing member 218 is coupled with the two carrier plates 200 to be able to move the carrier plates 200 horizontally. For this purpose, the pushing member 218 is moved such that the coupling portions 220 couple with the third coupling portions 202, 204 of the two carrier plates 200. In this way, the two carrier plates 200 can be pulled and pushed.

Furthermore, the pushing of two carrier plates 200 arranged next to each other can also be performed by means of the linear unit 48 without a coupling of the pushing member 218 with the carrier plates 200. For this purpose, the pushing member 218 can be moved to the second edge sides 72 of the two carrier plates 200 and brought into abutment with the second edge sides 72. Thereby, for example, the protrusions of the pushing member 218 can bear against the holding members 214 of the third coupling portions from the outside. When the pushing member is then moved in the insertion direction, the two carrier plates 200 are pushed in the insertion direction.

Furthermore, the transfer plate 42 of the loading system 10 of the third embodiment corresponds substantially to the transfer plate 42 of the loading system 10 of the second embodiment. These transfer plates 42 differ in the configuration of the recess 112. The recess 112 of the charging system of the third embodiment also extends from the bottom side to the top side of the transfer plate. However, the recess has a T-shaped cross-section. The recess 112 is configured such that the linear unit 48 can be moved vertically through the recess 112 when the pushing member 218 is in the retracted position. In other words, the recess 112 is adapted to the shape that the linear unit 48 has in the retracted position of the pushing member 218.

The sequence of the individual operating states of the charging system 10 of the third embodiment corresponds substantially to the sequence of the operating states of the charging system 10 of the second embodiment.

In FIG. 46, the initial and final states are thereby illustrated, in which all carrier plates 200 are arranged in the carrier plate holder 40. Prior to the start of a freeze-drying cycle, H2O2 decontamination of the freeze-drying module 14 is again performed in the initial state. After the freeze-drying cycle, a washing cycle can again be performed in the final state.

At the beginning of the freeze-drying cycle, carrier plates are again transferred from the carrier plate holder 40 into the freeze dryer. For this purpose, the carrier plates 200 are first transferred to the transfer plate 42 and then pushed from there onto a placement plate 52 of the freeze dryer 16.

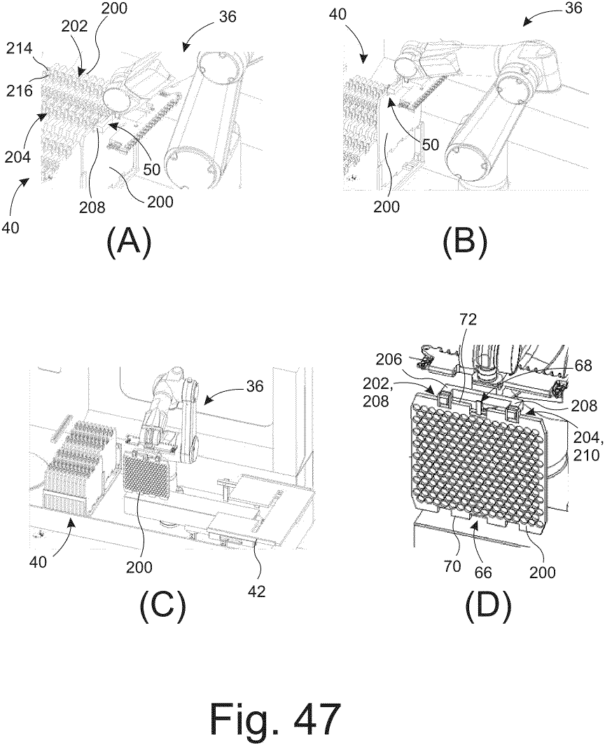

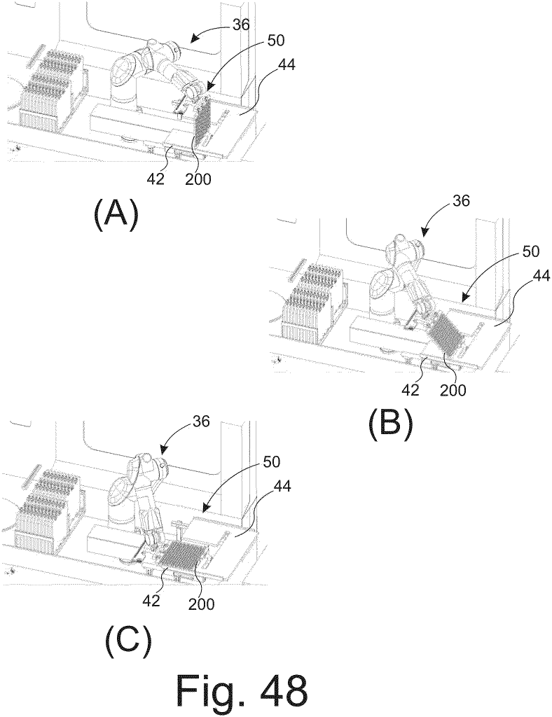

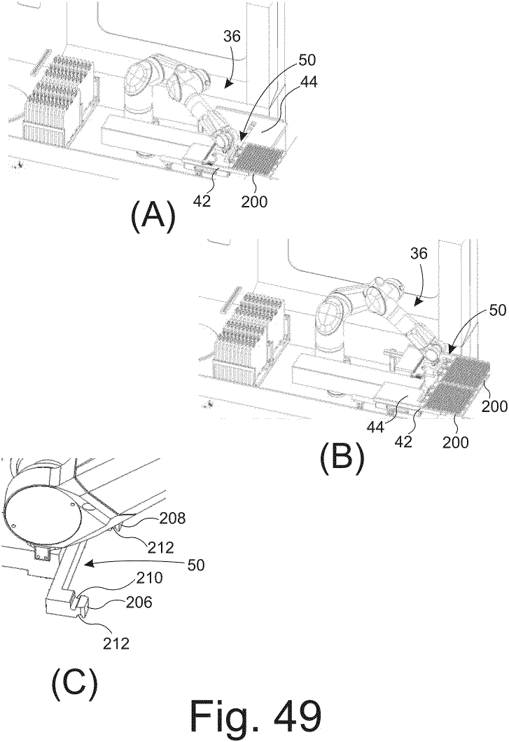

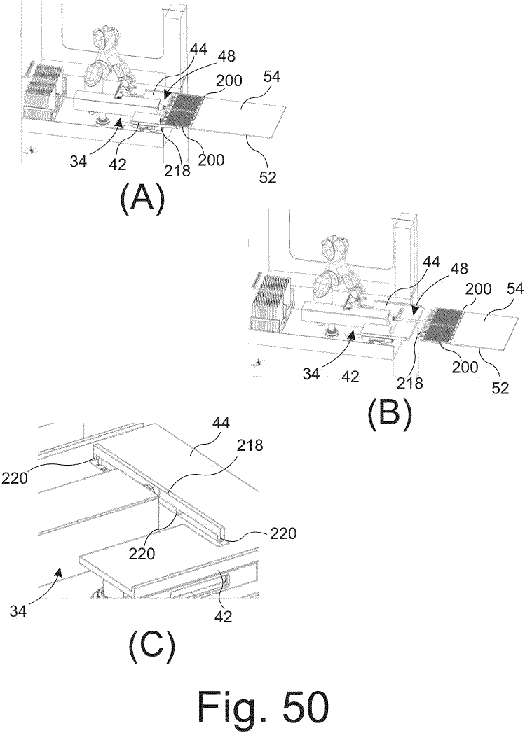

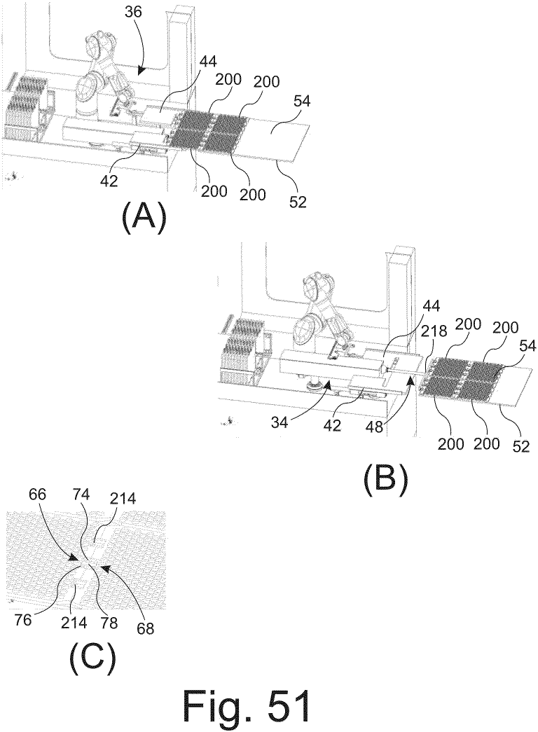

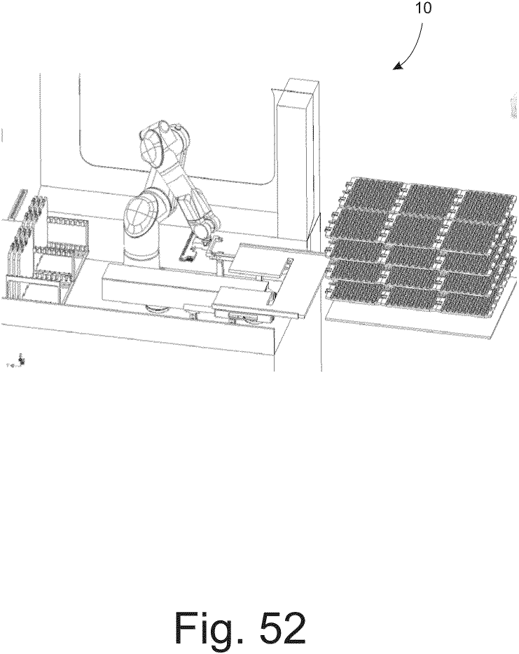

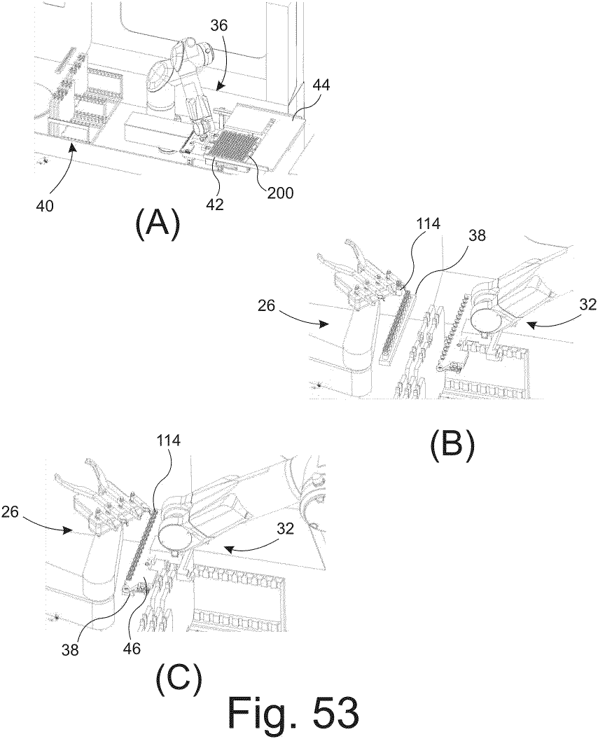

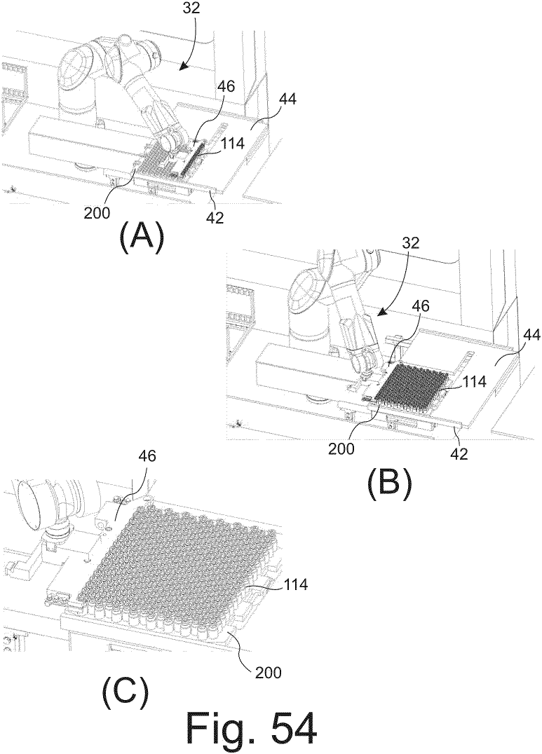

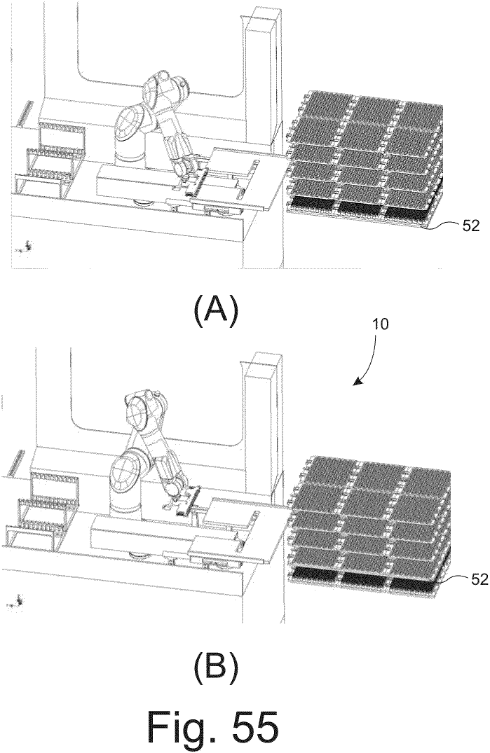

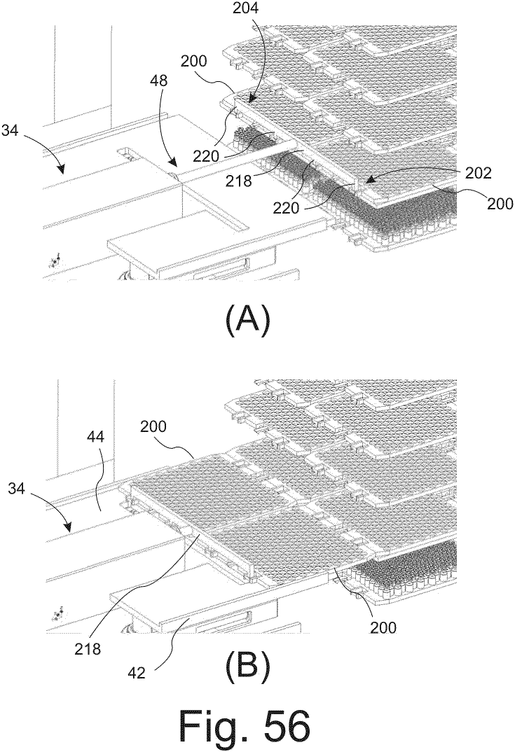

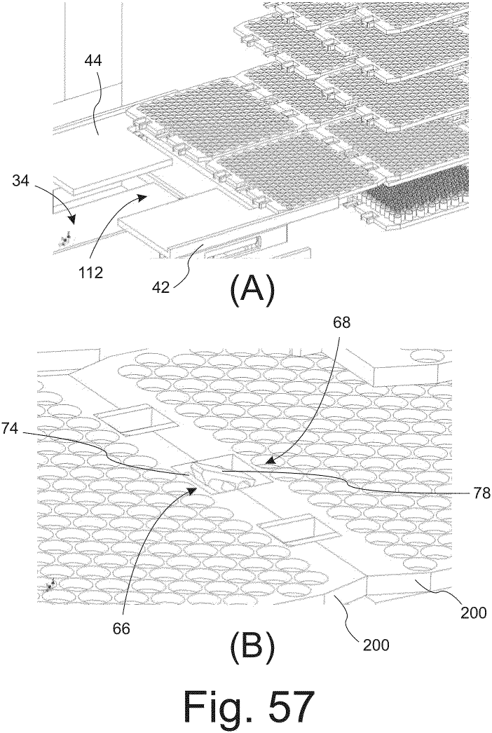

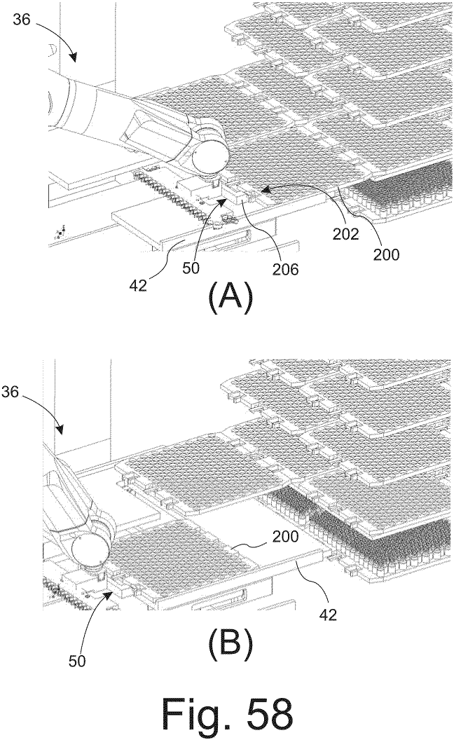

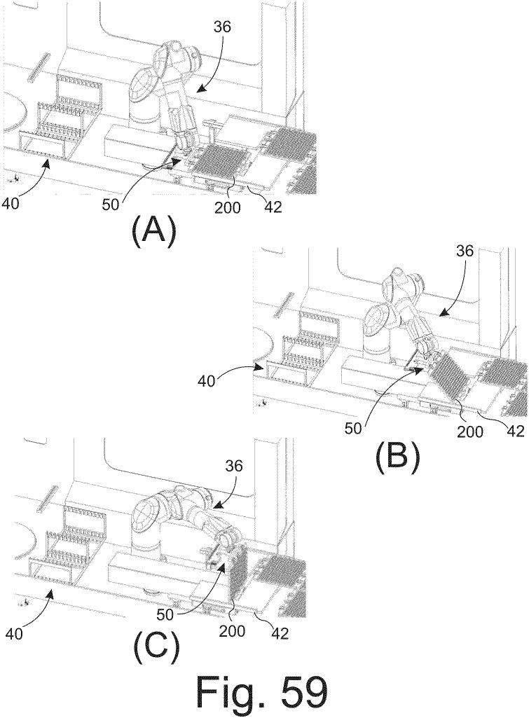

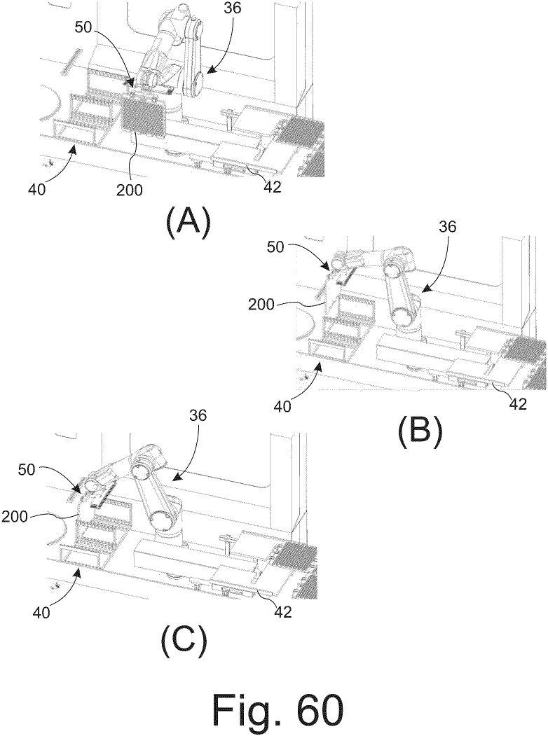

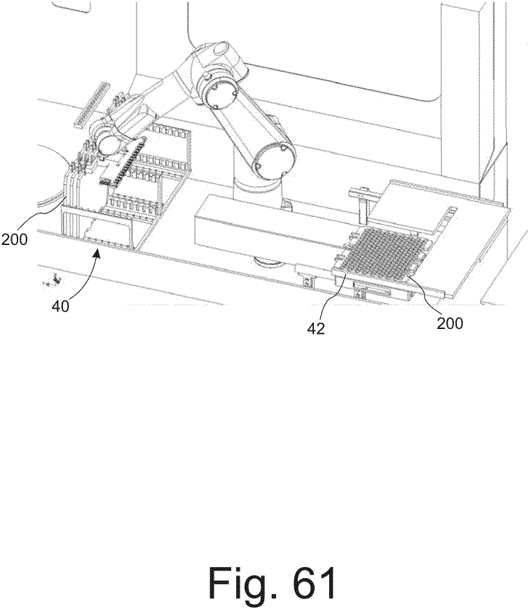

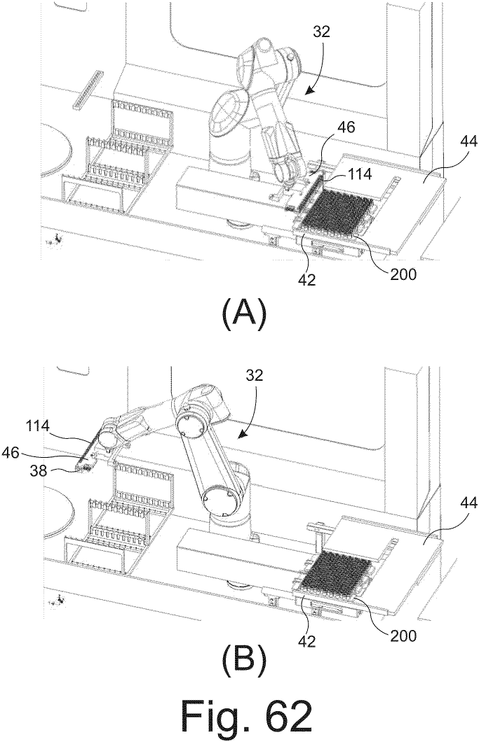

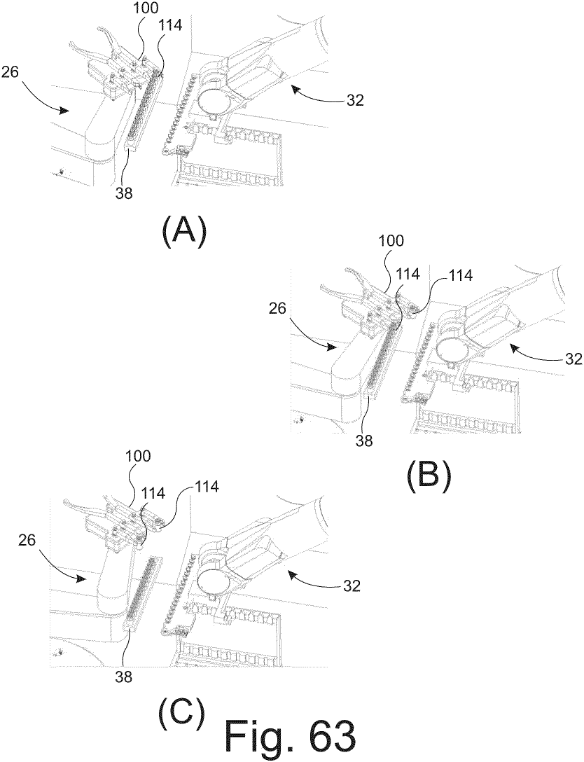

For transferring, by means of the third handling device 50, two carrier plates 200 are always removed one after the other from the carrier plate holder 40, transferred to the transfer plate 42, placed on it perpendicular to the insertion direction side by side, and positioned correspondingly on the transfer plate 42 for further handling. This is illustrated in FIGS. 47 (A) to (D), FIGS. 48 (A) to (C) and FIGS. 49 (A) and (B). For transferring, the upper coupling portions 210 are thereby coupled with the third coupling portions 202, 204 of the carrier plate 200 to be transferred prior to the removing and decoupled after the placing. Then, the transferred carrier plate 200 is positioned such that the linear unit 48 can be moved through the recess by means of the stroke unit 106. For this purpose, the carrier plate 200 is pushed so far in the insertion direction until the third coupling portions 202, 204 are at least no longer arranged above the recess 112. For pushing the carrier plate 200, the lower coupling portions 212 are thereby coupled with the third coupling portions 202, 204 of the carrier plate 200 to be positioned and decoupled again after pushing. In this way, two carrier plates 200 are always arranged next to each other on the transfer plate 42 and at least partially pushed into the freeze dryer 16. The configuration of the lower coupling portions 212 is illustrated in FIG. 49 (C).

Then, the two carrier plates 200 arranged on the transfer plate 42 are pushed together in the insertion direction onto one of the placement plates 52. For this purpose, the linear unit 48, which is previously arranged below the transfer plate 42, is moved through the recess 112 of the transfer plate 42 in order to arrange the linear unit above the transfer plate 42, in particular at the level of the two carrier plates 200. The linear unit 48 is thereby arranged such that the pushing member 21 lies against both carrier plates 200. In particular, two coupling portions 220 of the pushing member 218, in particular the protrusions of the coupling portions 220, thereby each lie against a respective one of the two carrier plates 200 on the respective second edge side 72. In particular, these protrusions lie against the outer side of a corresponding holding member 214 of the third coupling portions 202, 204. Due to displacement of the pushing member 218 in the insertion direction, the two carrier plates 200 are then pushed together into the freeze dryer 16 onto the corresponding placement surface 54. This is illustrated in FIGS. 50 (A) and (B). In FIG. 50 (C) , the configuration of the pushing member 218 is illustrated.

In this way, four further carrier plates 200 are removed from the carrier plate holder 40 and pushed onto the same placement surface 54 of the freeze dryer 16, so that six carrier plates 200 are arranged on the placement surface 54 of the freeze dryer 16. The carrier plates 200 are arranged such that three carrier plates 200 are each arranged one after the other in the insertion direction, and two carrier plates 200 are each arranged next to each other perpendicular to the insertion direction. The carrier plates 200 that are arranged one after the other in the insertion direction are coupled with each other. The coupling of the carrier plates 200 by means of the corresponding first and second coupling portions 66, 68 is performed automatically during the inserting. This is illustrated in FIGS. 51 (A) to (C) . The coupling is performed by means of the hooking mechanism that is actuated by flank actuation.

Corresponding to the procedure described in FIGS. 47 to 51, all placement surfaces 54 of the freeze dryer 16 except one are loaded with six carrier plates 200 each. In other words, as many carrier plates 200 are inserted into the freeze dryer until only six carrier plates 200 are still arranged in the carrier plate holder 40. This state is illustrated in FIG. 52.

These six carrier plates 200 are then transferred one after the other corresponding to FIGS. 47 and 48 from the carrier plate holder 40 to the transfer plate 42, arranged on the transfer plate 42, and equipped with containers 114. This is illustrated in FIGS. 53 (A) to (C) and 54 (A) to (C) . As soon as two carrier plates 200 are each equipped with containers 114, these carrier plates 200 are pushed together from the transfer plate 42 onto the placement plate 52 by means of the second handling device 34. The inserting of the equipped carrier plates 200 is performed corresponding to the inserting of empty carrier plates 200, as illustrated in FIGS. 49 to 51. In this way, six carrier plates 200 are removed from the carrier plate holder 40, equipped with containers 114 on the transfer plate 42 and pushed into the freeze dryer 16. This state is illustrated in FIG. 55 (A).

Then, the placement plates 52 of the freeze dryer are displaced vertically so that a placement plate 52 having empty carrier plates 200 is arranged in one plane with the transfer plate 42. This is illustrated in FIG. 55 (B).

Then, the six empty carrier plates 200 that are arranged on this placement plate 52 are removed from the freeze dryer 16, and five of the six removed carrier plates 200 are then arranged in the carrier plate holder 40, wherein the sixth carrier plate 200 remains on the transfer plate 42 after the removing.

For this purpose, the carrier plates 200 are pulled in pairs one after the other against the insertion direction from the placement surface 54 onto the transfer plate 42 by means of the second handling device 34. This is illustrated in FIGS. 56 (A) and (B). As previously described, each of the front carrier plates 200 is coupled with one of the middle carrier plates 200 via the corresponding coupling portions 66, 68, and each of the middle carrier plates 200 is coupled with one of the rear carrier plates 200 via the corresponding coupling portions 66, 68. For pulling out, the coupling portions 220 of the pushing member 218 of the linear unit 48 of the second handling device 34 are coupled with the corresponding third coupling portions 202, 204 of the two carrier plates 200 to be pulled out. The carrier plates 200 are then pulled out by means of the second handling device 34 so far that the second coupling portions 68 of the following carrier plates 200 are no longer arranged on the placement surface 54, so that the carrier plates 200 to be pulled out are automatically decoupled from the following carrier plates 200. Thereafter, the linear unit 48 is moved vertically downward by means of the stroke unit 106 so that the linear unit 48 is arranged below the transfer plate 42. This is illustrated in FIGS. 57 (A) and (B).

Then, the two pulled-out carrier plates 200 are pulled further onto the transfer plate 42 by means of the third handling device 36, one after the other against the insertion direction, and transferred to the carrier plate holder 40. For this purpose, the lower coupling portions 212 of the receiving device 50 are first coupled with the third coupling portions 202, 204 of the carrier plate 200 to further pull the carrier plate. The carrier plates 200 are thereby pulled onto the transfer plate so far until the third coupling portions 202, 204 project over the edge on the side of the transfer plate 42 facing away from the freeze dryer 16. This is illustrated in FIG. 58 (A) and (B). Then, by means of the third handling device 36, the carrier plate 200 is transferred from the transfer plate 42 to the carrier plate holder 40 and arranged therein. For transferring, the upper coupling portions 210 are coupled with the third coupling portions 202, 204 of the carrier plate 200. This is illustrated in FIGS. 59 (A) to (C) and 60 (A) to (C) .

Corresponding to FIGS. 56 to 60, five of the six carrier plates 200 are arranged in the carrier plate holder 40. The sixth carrier plate 200 remains on the transfer plate 42, as illustrated in FIG. 61. Thereby, the carrier plate 200 is again arranged such that the third coupling portions 202, 204 project over the edge of the transfer plate 42 on the side facing away from the freeze dryer 16.

Corresponding to FIGS. 53 to 61, all placement plates 52 carrying empty carrier plates 200 are displaced one after the other to the level of the transfer plate 42, wherein the empty carrier plates 200 are then removed from this placement plate 52, equipped with containers 114 and pushed back onto the placement plate 52. In this way, all carrier plates 200 are equipped with containers 114 and inserted into the freeze dryer 16.

After the freeze-drying, the containers 114 can then be correspondingly removed from the freeze dryer 16 and discharged again. For this purpose, the carrier plates 200 are again pulled one after the other from the placement surfaces 54 onto the transfer plate 42 by means of the second handling device 34. Then, there the containers 114 are removed by means of the first handling device 32 and transferred to the container holder 38. This is illustrated in FIGS. 62 (A) and (B).

Then, the containers 114 are removed from the container holder 38 by means of the transport device 26 and transported away. This is illustrated in FIGS. 63 (A) to (C) . For this purpose, the gripping tool 100 grips two containers 114 each and transports them away. The gripping tool can receive the two containers 114 one after the other. Subsequently, the transport device 26 can transfer the containers 114 to the crimping module 20.

Each emptied carrier plate 200 is then transferred to the carrier plate holder 40 by means of the third handling device 36 and arranged in one of the receptacles 56. In this way, all carrier plates 200 are emptied and subsequently transferred back to the carrier plate holder 40.

After all of the carrier plates 200 are emptied and arranged in the carrier plate holder 40, a wash cycle can again be performed by cleaning the carrier plates 200, for example, by means of a sprinkler system.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A loading system for a freeze dryer, wherein the loading system is configured to load and/or unload the freeze dryer with containers filled with a medical, pharmaceutical or cosmetic substance, wherein the loading system comprises: a handling station and at least one carrier plate, wherein each carrier plate comprises a plurality of receptacles configured to each receive one of the containers, wherein the handling station comprises at least one handling device configured to handle the carrier plate in the handling station.

2. The loading system as claimed in claim 1, wherein a first handling device of the at least one handling device is configured to insert the containers into the receptacles of the carrier plate and/or to remove them again after freeze-drying.

3. The loading system as claimed in claim 1, wherein a first handling device of the at least one handling device comprises a handling robot having a gripping device for gripping containers.

4. The loading system as claimed in claim 1, wherein the loading system comprises a transport device configured to feed the containers to the handling station and/or to remove the freeze-dried containers from the handling station.

5. The loading system as claimed in claim 4, wherein the transport device comprises a handling robot configured to handle the containers individually or several containers together.

6. The loading system as claimed in claim 1, wherein the handling station comprises a container holder in which fed containers and/or containers to be transported away are arrangeable.

7. The loading system as claimed in claim 6, wherein a first handling device of the at least one handling device is configured to remove the containers from the container holder, transfer them to the carrier plate and insert them into empty receptacles of the carrier plate.

8. The loading system as claimed in claim 6, wherein the container holder comprises a plurality of receptacles for receiving a respective container.

9. The loading system as claimed in claim 8, wherein the receptacles of the container holder are arranged in a row, wherein a first handling device of the at least one handling device is configured to handle a row of containers.

10. The loading system as claimed in claim 1, wherein a second handling device of the at least one handling device is configured to insert the carrier plate into the freeze dryer for loading the freeze dryer and/or to remove the carrier plate from the freeze dryer again for unloading the freeze dryer.

11. The loading system as claimed in claim 10, wherein the second handling device is configured to push the carrier plate from the handling station into the freeze dryer for loading the freeze dryer and/or to pull the carrier plate out of the freeze dryer again for unloading the freeze dryer.

12. The loading system as claimed in claim 11, wherein the second handling device comprises a linear unit by means of which the carrier plate is pushable.

13. The loading system as claimed in claim 12, wherein the carrier plate comprises at least one coupling portion, wherein the linear unit is couplable with the coupling portion to pull the carrier plate.

14. The loading system as claimed in claim 10, wherein the freeze dryer comprises at least one placement surface for the containers, wherein the carrier plate is pushable onto the placement surface and/or pullable out from the placement surface by means of the second handling device.

15. The loading system as claimed in claim 14, wherein the freeze dryer comprises a plurality of placement surfaces.

16. The loading system as claimed in claim 15, wherein the placement surfaces are vertically movable within the freeze dryer.

17. The loading system as claimed in claim 16, wherein the placement surfaces of the freeze dryer are vertically movable such that, for inserting and/or removing the carrier plate, one of the placement surfaces is arrangeable substantially in a plane with a transfer surface of a transfer plate.

18. The loading system as claimed in claim 1, wherein the handling station comprises a transfer plate on which the carrier plate is arrangeable in the handling station for loading and/or unloading.

19. The loading system as claimed in claim 14, wherein the second handling device is configured to push the carrier plate from a transfer plate onto the placement surface and/or pull the carrier plate from the placement surface onto the transfer plate.

20. The loading system as claimed in claim 1, wherein the handling station comprises a carrier plate holder configured to hold a plurality of carrier plates.

21. The loading system as claimed in claim 20, wherein a third handling device of the at least one handling device is configured to transfer a carrier plate between the carrier plate holder and a transfer plate.

22. The loading system as claimed in claim 21, wherein the third handling device is configured to remove the carrier plate from the carrier plate holder, transfer it to the transfer plate and arrange it on the transfer plate and/or receive it from the transfer plate, transfer it to the carrier plate holder and arrange it in the carrier plate holder.

23. The loading system as claimed in claim 21, wherein each carrier plate comprises at least one coupling portion and the third handling device comprises a receiving device, wherein the receiving device is couplable with the coupling portion of one of the carrier plates so that the third handling device can transfer the carrier plate in the coupled state.

24. The loading system as claimed in claim 2, wherein the first handling device and a third handling device are configured by a handling robot, wherein the handling robot comprises an end effector comprising a gripping device of the first handling device and a receiving device of the third handling device.

25. A freeze-drying system having a freeze dryer and the loading system according to claim 1.

26. A method for handling containers filled with a medical, pharmaceutical or cosmetic substance in a loading system for a freeze dryer, wherein the method comprises the following steps for loading the freeze dryer:
providing a carrier plate in a handling station, wherein the carrier plate comprises a plurality of receptacles configured to each receive one of the containers;
feeding containers to the handling station;
inserting the containers into the receptacles of the carrier plate by means of a first handling device; and
inserting the carrier plate into the freeze dryer by means of a second handling device.

27. The method as claimed in claim 26, wherein the step of feeding containers further comprises the following steps:
transporting the containers to a container holder of the handling station by means of a transport device; and
arranging the fed containers in the container holder.

28. The method as claimed in claim 27, wherein the container holder comprises a plurality of receptacles, wherein the containers are inserted into the receptacles for arranging the containers in the container holder.

29. The method as claimed in claim 27, wherein the step of inserting the containers into the receptacles of the carrier plate by means of the first handling device further comprises the following steps:
removing one or several containers from the container holder;
transferring the removed containers to the carrier plate; and
inserting the transferred containers into empty receptacles of the carrier plate.

30. The method as claimed in claim 26, wherein the carrier plate is arranged on a transfer plate in the handling station for loading and/or unloading.

31. The method as claimed in claim 26, wherein in the step of inserting the carrier plate into the freeze dryer, the carrier plate is pushed from the handling station into the freeze dryer by means of the second handling device.

32. The method as claimed in claim 31, wherein the carrier plate is pushed from a transfer plate of the handling station onto a placement surface of the freeze dryer.

33. The method as claimed in claim 26, wherein the step of providing the carrier plate further comprises the following steps:
arranging a plurality of carrier plates in a carrier plate holder of the handling station; and
transferring the carrier plate from the carrier plate holder to a transfer plate by means of a third handling device.

34. The method as claimed in claim 33, wherein each carrier plate comprises at least one coupling portion and the third handling device comprises a receiving device coupleable with the coupling portion, wherein the step of providing the carrier plate further comprises the following steps:
coupling the third handling device with one of the carrier plates arranged in the carrier plate holder prior to the step of transferring; and
decoupling the third handling device from the carrier plate after the step of transferring.

35. The method as claimed in claim 26, wherein the method further comprises the following steps for unloading the freeze dryer:
removing the carrier plate from the freeze dryer by means of the second handling device;
removing the containers from the receptacles of the carrier plate in the handling station by means of the first handling means; and
removing the containers from the handling station by means of a transport device.

36. The method as claimed in claim 35, wherein in the step of removing the carrier plate from the freeze dryer, the carrier plate is pulled out of the freeze dryer by means of the second handling device, wherein the carrier plate is pulled from a placement surface onto a transfer plate of the handling station.

37. The method as claimed in claim 35, wherein the step of removing the containers from the receptacles of the carrier plate by means of the first handling device further comprises the following steps:
removing one or several containers from the receptacles of the carrier plate;
transferring the removed containers to a container holder; and
inserting the transferred containers into the container holder.

38. The method as claimed in claim 37, wherein the removing of the containers from the container holder comprises:
removing the containers from the container holder; and
transporting the containers away by means of the transport device or a further transport device.

39. The method as claimed in claim 35, wherein the method further comprises, after the step of removing the containers from the receptacles of the carrier plate, the following step:
storing the carrier plate in the carrier plate holder.

40. The method as claimed in claim 39, wherein the step of storing the carrier plate in the carrier plate holder further comprises the following steps:
transferring the carrier plate from a transfer plate to the carrier plate holder by means of a third handling device; and
arranging the transferred carrier plate in the carrier plate holder.

41. The method as claimed in claim 40, wherein each carrier plate comprises at least one coupling portion and the third handling device comprises a receiving device couplable with the coupling portion, wherein the step of storing the carrier plate further comprises the following steps:
coupling the third handling device with a carrier plate arranged on the transfer plate prior to the step of transferring; and
decoupling the third handling device from the transferred carrier plate after the step of transferring.
